(19) United States
(12) Patent Application Publication
(10) Pub. No.: US 2005/0132087 A1
(43) Pub. Date: Jun. 16, 2005

(54) Method and apparatus for video signal skew compensation

(76) Inventors: Lech Glinski, Morris Plains, NJ (US); Yee Liaw, Warren, NJ (US)

Correspondence Address: Ward & Olivo, 708 Third Avenue, New York, NY, 10017, US

(21) Appl. No.: 10/735,246

(22) Filed: Dec. 12, 2003

(51) Int. Cl. H02H 9/00

(52) U.S. Cl. 709/238; 361/18

(57) ABSTRACT

Disclosed is a system and method for correcting the separation of synchronized video signals resulting from transmission over wires of different lengths. Preferably, circuitry is used to inject a signal pulse along the red, green, and blue video signal transmission lines through a selectable delay circuit to a skew compensation circuit located at a user workstation. The skew compensation circuit sums the amplitudes of the received signal pulses and compares the result to a reference amplitude. This is repeated for each possible delay combination of the selectable delay circuits. The skew compensation circuit then determines the delay combination which produces a summed amplitude most closely matching the reference amplitude. This delay combination is implemented in the selectable delay circuits and normal video transmission is allowed to resume such that the red, green, and blue components of the video signal arrive at the video monitor at approximately the same time.

### FIELD OF THE INVENTION

The present invention relates generally to KVM switches and the transmission of video signals over long distances. More specifically, the invention relates to a method and apparatus for the compensation or correction for the separation of synchronized signals transmitted over wires of different lengths.

### BACKGROUND OF THE INVENTION

A typical computer setup includes a central processing device, a keyboard, a video monitor, a cursor control device (e.g., a mouse), and associated peripheral devices, such as printers, scanners, etc. The wires utilized to connect the keyboard, video monitor, and cursor control device to the computer are typically of a length of twelve feet or less. If the length of the wires is increased, there is often too much signal degradation for the keyboard, video monitor, and cursor control device to function properly. A number of systems exist to alleviate this problem, thus allowing a keyboard, video monitor, and cursor control device to be located at an extended distance from a computer. For example, Asprey U.S. Pat. No. 5,257,390 (“Asprey”) discloses an extended range communications link for coupling a computer to a remotely located cursor control device, keyboard, and/or video monitor. The end of the link that is coupled to the computer has a first signal adjustment circuit that conditions the keyboard, video monitor, and cursor control device signals. Conditioning the video monitor signals includes reducing the amplitude of the signals in order to minimize the “crosstalk” induced on the conductors adjacent to the video signal conductors during transmission of the video signals. This signal conditioning circuit is coupled to an extended range cable having a plurality of conductors that transmits the conditioned signals and power and logic ground potentials to a second signal conditioning network. The second conditioning network restores the video signals to their original amplitudes.

As a further example, Perholtz et al. U.S. Pat. No. 5,732,212 (“Perholtz”) discloses a method and apparatus for accessing, controlling, and monitoring data located on a remote computer from a host computer. The video raster signal at the remote computer is converted to digital form and compressed after it has undergone a cyclic redundancy check. Software located on the host computer is capable of decoding the compressed video information and displaying it to a user on a standard video monitor. The remote computer and the host computer may be connected either via a modem connection (e.g., over telephone lines) or through standard network cabling. The Perholtz system is also capable of bi-directionally transmitting cursor control device and keyboard signals between the host computer and the remote computer.

In furtherance of these systems which allow a keyboard, video monitor, and cursor control device to be remotely located from a computer, systems currently exist which allow one or more workstations containing an attached keyboard, video monitor, and cursor control device to control a plurality of remote computers. Generally, the workstations and remote computers are attached to a central switching unit which allows any workstation to operate and control any remote computer. These systems are usually referred to as keyboard, video monitor, and mouse (“KVM”) switching systems. An example of such a system is disclosed in Beasley U.S. Pat. No. 6,345,323 (“Beasley”). Beasley disclosed a specific implementation of a computerized switching system for coupling a user workstation, including a keyboard, mouse, and/or video monitor, to one of a plurality of remotely located computers. In particular, a first signal conditioning unit, located at the user workstation, includes an on-screen programming circuit comprising an on-screen display device (“OSD”) processor, a logic device, a synchronization signal generator and switch, and buffers, utilized to display a menu of connected computers on the video monitor of the local workstation. After a connected remote computer is chosen, the first signal conditioning unit receives keyboard and mouse signals from the local workstation and generates a data packet comprising the keyboard and mouse signals for transmission to a central cross point switch. The cross point switch transmits the data packet to a second signal conditioning unit coupled to the selected, remotely located computer. The second signal conditioning unit then transmits the keyboard and mouse signals to the keyboard and mouse connectors of the remote computer. Video signals produced by the remote computer are transmitted through the second signal conditioning circuit, the cross point switch, and the first signal conditioning circuit to the video monitor at the local workstation. The horizontal and vertical synchronization video signals are encoded on one of the red, green, or blue components of the video signal to reduce the quantity of cables required to transmit the video signal from the remote computer to the local workstations video monitor. Generally, KVM switching systems known in the art utilize eight conductor wires, preferably in the form of Category 5 (“CAT 5”) cabling, to connect the workstations and remote computers to the KVM switch. CAT 5 cabling is typically utilized in computer network environments for Fast Ethernet, and consists of an outer housing containing a total of eight conductive wires separated into four twisted pair to minimize interference from other wires in the cable. Each twisted pair may include additional shielding to further prevent interference. Typically, each end of the CAT 5 cabling is terminated with a single Registered Jack 45 (RJ-45) connector.

Conventionally, when CAT 5 cabling is utilized in such systems, three of the twisted pairs are utilized to transmit the red, green, and blue components of the video signal while the fourth twisted pair is utilized to transmit the keyboard and mouse signals.

However, in conventional CAT 5 cabling, each of the four twisted pairs of wires does not typically have the same twist rate (i.e., pitch). As a result, the four twisted pairs of wires are often of different lengths, especially in a long cable. For example, there can be as much as thirty (30) feet difference in length between the shortest and longest wires among the four twisted pairs in a one thousand (1,000) foot CAT 5 cable. As is known in the art of signal transmission, the time it takes a signal to arrive at a destination is directly proportional to the wire length through which the signal must travel. Thus, the difference in the length the twisted pairs of wires causes the red, green, and blue components of the video signal to arrive at different times, resulting in video distortion known as “separation of colors,” because each color arrives at a different time on the video monitor.

A solution to this problem is to cause the red, green, and blue components of the video signal to arrive at the same time at the receiving end by inserting additional delays into the shorter twisted pairs of wires. Many systems for inserting a delay into a signal transmission are currently known in the art.

One such system corrects the delay which may occur between an input data signal and a clock signal. This system includes a transition detector for providing a signal upon the detection of a transition occurring between an input data signal and a clock signal. The signal causes a variable delay line to generate a first delayed data signal which lags the input data signal by a variable amount. In response to the first delayed data signal, a fixed delay line generates a second delayed data signal which lags the first delayed signal by a fixed amount. A phase detector located at a receiving end compares the relative phases of the second delayed data signal to the clock signal. If the second delayed data signal leads the clock signal, the phase comparator send a control signal to the variable delay line to increase the delay amount. If the second delayed data signal trails the clock signal, the phase comparator sends a control signal to the variable delay line to decrease the delay amount.

As another example, a method and apparatus is known for automatically calibrating the timings of a transceiver in a semiconductor device testing apparatus which comprises a plurality of input registers for transmitting signals and a plurality of output registers for receiving signals. The transceiver is driven by a main clock signal produced by a main clock. The system additionally contains a reference clock for supplying a reference clock signal for calibrating the registers. Automatic timing calibration is performed by distributing a reference clock signal from the reference clock to the output registers. A calibration means measures the phase separation of each of the reference clock signals as they arrive at the input registers and appropriately adjusts a phase shift means associated with each register for delaying the timing of that register.

Systems are also known for transmitting synchronized video over a cable containing multiple twisted pairs of wire wherein certain of these pairs are coupled to carry selected color signals. For example, in such a system, a user first records the twist rate of each of the twisted pairs of wire and connects the twisted pairs of wire having the lowest twist rates to the red, green, and blue components of the video signal. The user then manually implements a delay on the two twisted pairs of wire carrying video signals having the lowest twist rates (i.e., the shortest twisted pairs). The delay is implemented utilizing a series of printed circuit boards attached to the twisted pairs carrying the red, green, and blue components of the video signal. Each printed circuit board contains a number of printed delay circuits of different lengths designed to simulate a twisted pair transmission line of a limited and predetermined length. The printed delay circuits may be combined by the user to produce the delays of different lengths.

Other systems use a delay-locked loop with binary-coupled capacitors in a capacitor bank for re-synchronizing transmitted signals at a receiving end. Here, the binary-coupled capacitors produce a variable capacitance which allows the delay of a variable delay line to be varied. In response to a transmitted signal, the variable delay line produces a delayed output clock signal that is compared to the transmitted signals at a receiving end utilizing a race detection circuit. If the delayed output clock signal arrives before the transmitted signal, the race detection circuit increments a counter which increases the capacitance to the variable delay line to delay propagation of the delayed output clock signal. If the delayed output clock signals arrives after the transmitted signal, the race detection circuit decrements the counter to decrease the capacitance to the variable delay line to increase propagation of the delayed output signal. The variable delay line continuously outputs a delayed output clock signal until an arbitration circuit in the race detection circuit notifies the variable delay line that the output clock signal and the transmitted signal are synchronized. A method and apparatus for measuring and correcting the signal delay which occurs in a parallel phase locked loop is also known. Such a method and apparatus utilizes a plurality of programmable delay lines, with each delay line in the path of a corresponding signal which requires synchronization. Delay correction is performed utilizing a measuring circuit which determines the phase difference between two or more synchronized signals exhibiting a phase shift. Utilizing this information, the measuring circuit adjusts the delay lines to delay at least one of the signals in order to synchronize the signals.

Other methods for automatically re-synchronizing signals at a receiving end of a data node in a parallel data link are known. For example, in one such system, the amount of delay to each signal is measured during a “training” sequence initiated when a training packet is injected at the transmitting node. After the transmission of the training packet, a timing edge is injected into each of the transmission nodes simultaneously. When the training packet is received at the receiving end of the link, the receiving node measures the time at which each timing edge arrives. After determining the relative difference in times, the system implements the appropriate delay in the proper node utilizing an electronically switchable delay.

In view of the foregoing, a need clearly exists for an automatic skew compensation system and method for use in KVM switching systems capable of automatically correcting for the separation of synchronized video signals transmitted over wires of different lengths. Such a system should be transparent to a user of the system, and include a manual override in which a user may select each delay in cases where custom intervention is required for extreme conditions by utilizing the keyboard, video monitor, and cursor control device (e.g., mouse) of an attached user workstation.

### SUMMARY OF THE INVENTION

It is often convenient to control one or more remotely located computers from one local set of peripheral devices (i.e., keyboard, video monitor, cursor control device, etc.). Devices which allow control and operation of remotely located computers are typically referred to as keyboard, video monitor, and cursor control device (“KVM”) switches. Such KVM switches may include, for example, a series of user stations (“USTs”) having an attached keyboard, video monitor, and cursor control device connected to a central crosspoint switch preferably with cables having multiple twisted pairs of wires, such as standard CAT 5 cabling. The combination of the UST, keyboard, video monitor, and cursor control device is typically referred to as a user workstation. In turn, the central crosspoint switch is connected to a series of computer interface modules (“CIMS”) also via cabling with multiple twisted pairs of wires, such as CAT 5 cabling. Each CIM is connected to a single remote computer. A menu accessible from each user workstation allows a user to select a particular remote computer utilizing the user workstation's keyboard, video monitor, and cursor control device.

The cabling which connects the user workstations to the crosspoint switch and the crosspoint switch to the CIM preferably contains four twisted pairs of wires, of which three of the twisted pairs are used to transmit the red, green, and blue components of a video signal. The fourth twisted pair transmits the keyboard and cursor control device signals. Due to manufacturing constraints, each twisted pair of wires typically contains a different twist rate that causes the length between the shortest and the longest wires of the four twisted pairs to vary by as much as thirty (30) feet in a one thousand (1,000) foot cable. In video transmission, the time it takes for the video signal to traverse the length of the wire is directly proportional to the wire length. Therefore, the difference in lengths among the twisted pairs produces video distortion, known as “separation of colors,” where the components of the video signal arrive at separate times.

To correct this problem, the present invention provides a method and apparatus for compensating for the differences in length of the wires by delaying the video signals on the shorter wires so that all three video signals arrive at approximately the same time. Such automatic skew compensation is performed each time a user switches to a different remote computer since a different length of wire can be involved in each CAT 5 cable run. Upon switching to a different remote computer, an automatic skew calibration mode is entered, which injects a pulse of known amplitude and width into each of the red, green, and blue video transmission signals at the CIM. The system utilizes these pulses to assign the appropriate skew compensation, thus re-synchronizing the red, green, and blue components of the video signal.

An automatic skew compensation circuit located at the user workstation receives the pulse and adjusts a selectable delay circuit coupled to the three video transmission lines until each of the red, green, and blue components of the video signal arrive concurrently. Preferably, the present invention need not measure the delays between the signals or utilize a calibration look-up table to adjust the delays. Instead, the automatic skew compensation circuit sums the amplitudes of the three received test signals (pulses) and compares the summed signal to the reference signal. The result of the comparison is stored in a buffer memory. The comparison is performed for all possible delay combinations of the selectable delay circuits and typically takes under one second to complete. The delay combination which produces a summed amplitude closest to the reference amplitude is implemented in the selectable delay circuits and utilized for normal video transmission.

Once the proper delay combination is implemented, the automatic skew correction circuit sends a signal to the CIM directing it to stop sending the pulses. The automatic skew calibration mode is then exited and the system resumes normal video transmission of the red, green, and blue components of the video signal.

In an alternate embodiment, the test signals can be sent with the video signals as a composite signal thus obviating the need to interrupt the transmission of the video data. In this embodiment, the skew can be adjusted (1) whenever a new computer is selected for control; (2) periodically; (3) continuously; or (4) when selected by a user. Specifically, in this embodiment, the time pulse, as before is synchronously sent on each channel (red, green, and blue). However, in this embodiment, the pulse and video signals are combined and sent as one composite signal. Using standard signal extraction circuitry (e.g., such as circuitry commonly used to extract a video synchronization signal), the test pulses are extracted at the receiving end. Then, the time between each signal is measured to determine the skew that resulted from the signal transmission. Alternatively, once the pulses are extracted, as series of summations and comparisons to a reference signal can occur as described above. When the optimal delay needed for each signal is measured, the appropriate delay can be selected utilizing the selectable delay circuits described below.

According to the present invention, a manual override may be incorporated in which a user may utilize the keyboard and cursor control device to navigate an on-screen option menu to select each delay when custom intervention is required for extreme conditions. The setting for each selectable delay circuit is stored in the system, so, if the user switches channels, the setting will be restored when the user returns to the original channel.

The selectable delay circuit preferably includes a series of smaller delay circuits which may be selectively combined using a multiplexer to produce the desired delay. Alternatively, the delay circuits may be combined utilizing transistors or any other such switching element. One delay circuit which may be utilized with the present invention consists of a series of inductor-capacitor (“LC”) delay circuits with each delay element producing a known signal delay. The LC delay circuits may be combined utilizing a multiplexer or other switching means to produce the desired delay.

The selectable delay circuit may also utilize snaked wire traces on a printed circuit board to simulate longer transmission lines. Different wire traces of different lengths, shapes, or patterns on the circuit board may be combined using a multiplexer to produce the desired delay. In addition, other circuits capable of producing a delay in the transmission of a video signal may be utilized with the present invention.

Therefore, it is an object of the present invention to provide a method for automatically correcting the skew associated with the transmission of red, green, and blue video signals over wires of different length such that undistorted video is displayed on a monitor located at an extended distance from which the video signals originate. It is also an object of the present invention to provide an apparatus for automatically correcting the skew associated with the transmission of red, green, and blue video signals over wires of different length such that undistorted video is displayed on a monitor located at an extended distance from which the video signals originate.

It is also an object of the present invention to provide an automatic skew correction system that functions transparently to a user of the system.

It is another object of the present invention to provide an automatic skew correction system which allows a user to manually correct for skew associated with the transmission of red, green, and blue video signals over wires of different length.

It is yet another object of the present invention to provide an automatic skew correction system for use in a conventional KVM switching system.

Still another object of the present invention is to provide an automatic skew correction system which utilizes LC circuits to implement the appropriate signal delays for correcting the skew associated with the transmission of red, green, and blue video signals over wires of different lengths.

Furthermore, it is an object of the present invention to provide an automatic skew correction system which utilizes a printed circuit board to implement the appropriate signal delays.

It is a further object of the present invention to provide an automatic skew correction system which utilizes test pulse signals transmitted over the twisted pairs of wires configured to transmit the red, green, and blue components of the video to perform automatic skew compensation.

Other objects, features, and characteristics of the present invention, as well as the methods of operation and functions of the related elements of the structure, and the combination of parts and economies of manufacture, will become more apparent upon consideration of the following detailed description with reference to the accompanying drawings, all of which form a part of this specification.

### BRIEF DESCRIPTION OF THE DRAWINGS

A further understanding of the present invention can be obtained by reference to a preferred embodiment set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings in which:

FIG. 1 depicts a KVM remote management system according to the preferred embodiment of the invention illustrating the connection of a plurality of workstations that include keyboard, video monitor, and cursor control device to multiple remote computers, wherein the system includes a plurality of user station devices (“USTs”) and computer interface modules (“CIMs”) interconnected by at least one matrix switching unit (“MSU”).

FIG. 2 depicts a partial side view of the internal wires of a typical CAT 5 cable showing its outer housing and four twisted pair of wires for use in accordance with the preferred embodiment of the present invention.

FIG. 3 is a block diagram of the MSU shown in FIG. 1 according to the preferred embodiment of the present invention illustrating the internal structure of the MSU and the ports for connecting CAT 5 cables.

FIG. 4A is a block diagram of the CIM shown in FIG. 1 according to the preferred embodiment of the present invention illustrating the internal structure of the CIM including a signal injection circuit utilized for the automatic skew compensation calibration feature of the present invention, the connection to a remote computer, and the port for connecting a CAT 5 cable leading to the MSU.

FIG. 4B is a detailed block diagram of the signal injection circuit shown in FIG. 4A.

FIG. 5 is a diagram of a data packet according to the preferred embodiment of the present invention illustrating the individual segments that comprise the data packet.

FIG. 6A is a block diagram of the UST shown in FIG. 1 depicting the attached peripheral devices, connection to the MSU via CAT 5 cabling, and the internal structure of the UST including an automatic signal tuning circuit, and a circuit for providing automatic skew compensation of the transmitted video signals according to the preferred embodiment of the present invention.

FIG. 6B is a block diagram that depicts the preferred embodiment of the automatic skew compensation circuit shown in FIG. 6A.

FIG. 6C is an enhanced block diagram of the automatic skew compensation circuit of FIG. 6B.

FIG. 6D is a block diagram of the preferred embodiment of the skew tuning circuit of the automatic skew compensation circuit depicted in FIGS. 6A-6C.

FIG. 6E is a block diagram that depicts an alternate embodiment of the automatic skew compensation circuit shown in FIG. 6A.

FIG. 6F is an enhanced block diagram of the automatic skew compensation circuit of 6E.

FIG. 6G is a block diagram of an alternate embodiment of the skew tuning circuit of the automatic skew compensation circuit depicted in FIGS. 6E-F.

FIG. 6H is a block diagram of the tuning circuit depicted in FIG. 6A.

FIG. 6I is a schematic diagram of the preferred embodiment of the selectable delay circuit of the automatic skew compensation circuit depicted in FIGS. 6B-6C.

FIG. 7 is a schematic diagram of an alternate embodiment of the automatic skew compensation circuit in accordance with the present invention, which synchronizes differential video signals.

FIG. 8 depicts a circuit diagram of an alternate embodiment for the selectable delay circuit according to the present invention, which utilizes traces on a printed circuit board.

FIG. 9 is a block diagram of yet another alternate embodiment of the selectable delay circuit according to the present invention.

FIG. 10A is a block diagram of a manually adjustable skew compensation circuit for providing adjustment of the delay applied to each of the red, green, and blue components of the video signal.

FIG. 10B is an enhanced block diagram of the manually adjustable skew compensation circuit of FIG. 10A.

### DETAILED DESCRIPTION OF THE PREFERRED EMBODIMENTS

As required, a detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention. The following presents a detailed description of the preferred embodiment (as well as some alternative embodiments) of the present invention.

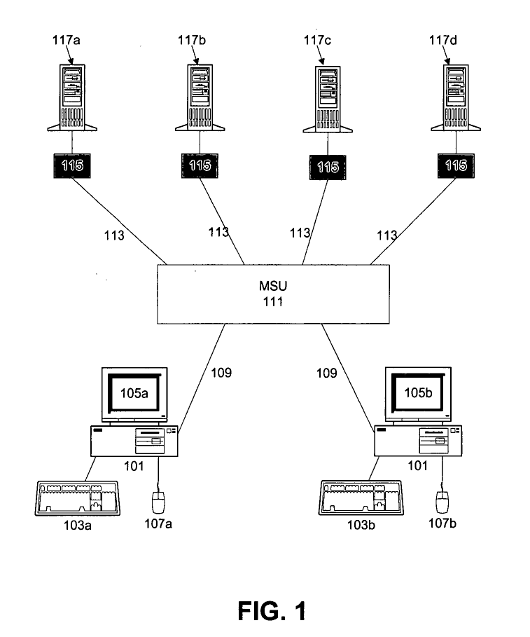

Referring first to FIG. 1, depicted is a conventional KVM switching system including user stations (“USTs”) 101 are shown with attached keyboards 103, video monitors 105, and cursor control devices 107. Each UST 101 is connected via cable 109 to matrix switching unit (“MSU”) 111. Each cable 109 may be a different length depending upon the location of each UST 101 and MSU 111. Similarly, MSU 111 is connected to each CIM 115 via cable 113. Again, each cable 113 may be of different length depending upon the relative locations of each MSU 111 and each CIM 115. In turn, each CIM 115 is connected to a single remote computer 117.

CAT 5 cabling is the preferred cabling for use with the present invention because it reduces cabling cost while maintaining the signal strength for signals that are transmitted over an extended distance. Additionally, the use of single CAT 5 cabling minimizes the space required to house the computer system.

Individual CAT 5 cables may be used for connection of each UST 101 and each CIM 115 to MSU 111. Conventional CAT 5 cables include eight (8) conductor wires arranged into four (4) twisted pair of wires to prevent interference from the other wires in the cabling. The ends of a CAT 5 cable are typically terminated with a conventional Registered Jack 45 (“RJ-45”) connector. Conventionally, CAT 5 cable is commonly used in computer networking environments where the CAT 5 cables connect a plurality of computers to a central hub, server, or router for, communications such as TCP/IP communications.

Remote management systems, for example, KVM switching systems, use CAT 5 cabling to take advantage of the four twisted pair of wires. Such systems utilize three (3) of these twisted pair for the transmission of video signals. Each of the three (3) twisted pair transmits one of the three video color signals (i.e., red, green, or blue). To allow all video signals to be transmitted on only (3) twisted pair, the horizontal and vertical synchronization signals, which would otherwise require their own twisted pairs, are each encoded on one of the three color video signals. Each synchronization signal is encoded on its own, dedicated color signal. For example, the vertical synchronization signal may be encoded on the blue video signal while the horizontal synchronization signal may be encoded on the green video signal. All other non-video signals, such as keyboard and cursor control device data, are transmitted via the fourth twisted pair.

However, in typical CAT 5 cabling, each of the three twisted pair of wires responsible for carrying the red, green, and blue components of the video signal are typically of different lengths. For example, there may-be as much as thirty (30) feet difference in length between the shortest and longest wires among the twisted pairs of a thousand (1,000) foot cable. As a result, the red, green, and blue components of the video signal arrive at the video monitor at different times, resulting in video distortion known as “separation of colors” because each color arrives at a different time on the video monitor. The present invention corrects for such “separation of colors” and thereby reduces or eliminates such video distortion.

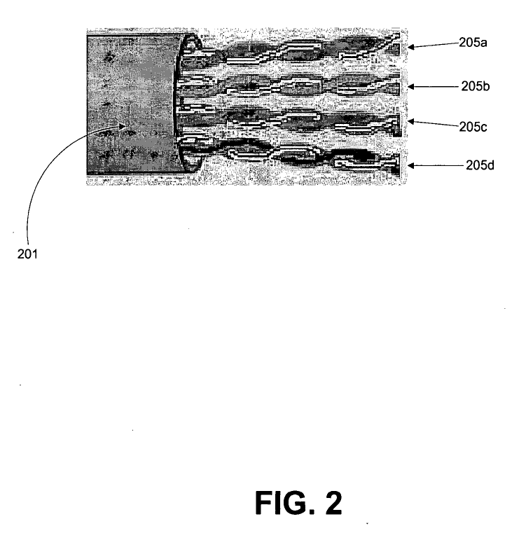

As shown in FIG. 2, CAT 5 cabling typically contains outer housing 201 and four sets of twisted pair wires 205a, 205b, 205c, and 205d. In the disclosed remote management system, three of the twisted pairs (e.g., 205a, 205b, and 205c) are utilized to transmit the unidirectional differential signals associated with the red, green, and blue components of the video signal. The fourth twisted pair (e.g., 205d) is utilized to transmit the bi-directional keyboard and cursor control device signals. Each of the twisted pairs 205a, 205b, 205c, and 205d typically contains a different twist rate to compensate for crosstalk and other interference phenomenon. The twist rate is defined as the number of twists in a given distance (i.e., the pitch of the twisted pair). Therefore, the actual length of the wires used for each twisted pair 205a, 205b, 205c, and 205d may vary significantly. Such variations in the length of each twisted pair 205a, 205b, and 205c result in color separation of the video (i.e., the component of the video transmitted on the shortest wire arrives before the other video components). To alleviate this problem, the present invention provides a system capable of adjusting for the different lengths in the different twisted pairs 205a, 205b, and 205c.

The single CAT 5 cables are connected to UST 101, MSU 111, and CIM 115 by plugging each end into a RJ-45 socket located on the respective pieces of equipment. Although RJ-45 sockets and plugs are preferred, other types of connectors may be used, including but not limited to RJ-11, RG-58, RG-59, British Naval Connector (“BNC”), and ST connectors, although appropriate adaptors may be needed for some or all of these alternate connectors.

Preferably, CIM 115 is compatible with all commonly used, present day computer operating systems and protocols, including, but not limited to, those manufactured by Microsoft Corporation (“Microsoft”) (Windows), Apple Computer, Inc. (“Apple”) (Macintosh), Sun Microsystems, Inc. (“Sun”) (Unix), Digital Equipment Corporation (“DEC”), Compaq Computer Corporation (“Compaq”) (Alpha), International Business Machines (“IBM”)(RS/6000), Hewlett-Packard Company (“HP”) (HP9000), and SGI (formerly “Silicon Graphics, Inc.”) (IRIX). However, because the technology of the present invention is generally not operating system dependent, it is foreseeable that the present invention will also be compatible with those computer systems not yet contemplated. Additionally, local devices may communicate with remote computers via a variety of protocols including Universal Serial Bus (“USB”), American Standard Code for Information Interchange (“ASCII”), and Recommend Standard-232 (“RS-232”).

The remote management system for use with the present invention may be configured to connect any number of USTs 101 with any number of remote computers 117. Preferably, the system allows eight (8) user workstations 101 to be connected to thirty-two (32) CIMs 115 via one MSU 111 while still achieving optimal signal transmission. If additional user workstations 101 or CIMS 115 must be added, multiple MSUs 111 may be utilized to connect as many as thirty-two (32) USTs 101 to ten thousand (10,000) CIMS 115 and remote computers 117.

Selection of a remote computer 117 from a UST 101 may be accomplished using a variety of methods. One such method is choosing a remote computer 117 from a list displayed at the UST's 101 attached video monitor 105. This menu may be generated by circuitry within the system utilizing conventional on-screen display (“OSD”) technology. This circuitry and display facilitates system programming and provides information useful for system operation. Furthermore, multiple security features such as passwords, system user histories, etc. may be implemented and operated in conjunction with the menu generating circuitry circuit.

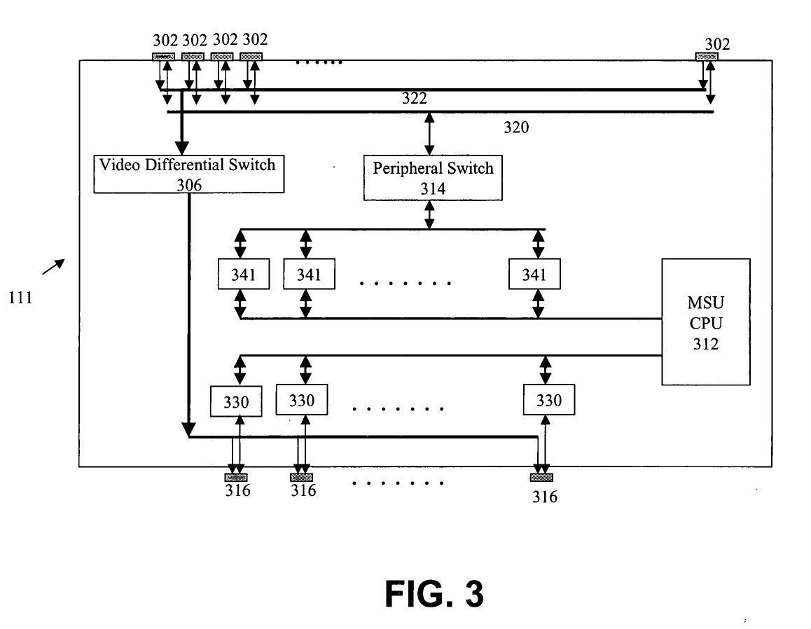

Turning next to FIG. 3, depicted is a block diagram of the component MSU 111 of the remote management system, which enables multiple users to access and operate a plurality of remote computers 117 (FIG. 1). Access by a user to one of the remote computers 117 from a local UST 101 is performed via one or more MSUs 111, independent of any network that may couple remote computers 117 to each other, such as a Local Area Network (“LAN”), Wide Area Network (“WAN”), etc. In other words, the disclosed remote management system preferably does not utilize an existing computer network to allow a local UST 101 to control the remote computers. Rather, it is preferred that all physical connections between the local USTs 111 and remote computers 117 occur through one or more MSUs 111.

Preferably, MSU 111 comprises a plurality of CIM ports 302 that are RJ-45 sockets, which allow each CIM 115 to be directly connected to MSU 111 via cable 113 (FIG. 1). Unidirectional video signals, transmitted from the remote computer to the user workstation, are received at MSU 111 through CIM ports 302 onto video bus 322, whereupon they are transmitted to video differential switch 306. Video differential switch 306 is capable of transmitting any video signal received from video bus 322 to any UST port 316. The video signal is then transmitted via cable 109 to attached UST 101 (FIG. 1).

In addition to sending video signals from a CIM 115 to a UST 101, MSU 111 provides bi-directional transmission of keyboard and cursor control device signals between USTs 101 and CIMs 115 (FIG. 1). For example, signals from one CIM 115 are received through CIM ports 302 onto peripheral bus 320, whereupon they are transmitted to peripheral switch 314. Peripheral switch 314 transmits these signals to the appropriate CIM universal asynchronous receiver transmitter (“UART”) 341, which de-serializes the keyboard and cursor control device signals (i.e., converts the signals from a serial format to a format that is compatible with MSU CPU 312 of MSU 111, e.g., parallel format) and transmits them to MSU CPU 312. MSU CPU 312 analyzes the received signals and generates new signals, also containing data packets, which are transmitted to the appropriate UST UART 330 where they are serialized and transmitted to the appropriate UST port 316 for further transmission via cable 109 to the appropriate UST 101 (FIG. 1).

Conversely, MSU 111 also transmits keyboard and cursor control device signals received from the local user workstation 100 and UST 101 to CIM 115 and the connected remote computer 117 (FIG. 1). The keyboard and cursor control device signals are received at UST 101 (FIG. 1) and transmitted via cable 109 to the respective UST port 316 and UST UART 330 of MSU 111. UST UART 330 de-serializes the signals and transmits them to MSU CPU 312. MSU CPU 312 interprets the information contained in the data packets of the received signals to create new signals, which also represent newly generated data packets. These new signals are then transmitted to the appropriate CIM UART 341 that is associated with the desired remote computer 117. CIM UART 341 serializes the signals and transmits them to peripheral switch 314, which transmits the signals to the desired CIM port 302 via peripheral bus 320. Subsequently, the keyboard and cursor control device signals are transmitted via cable 113 to the appropriate CIM 115, which is directly connected to the desired remote computer 117 (FIG. 1).

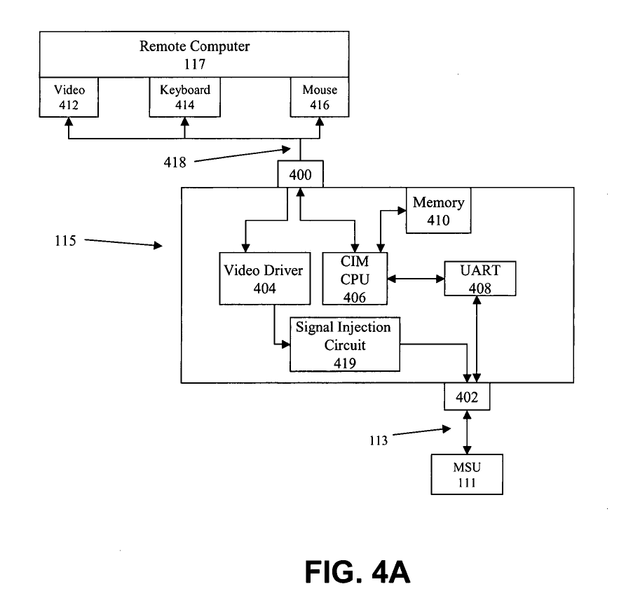

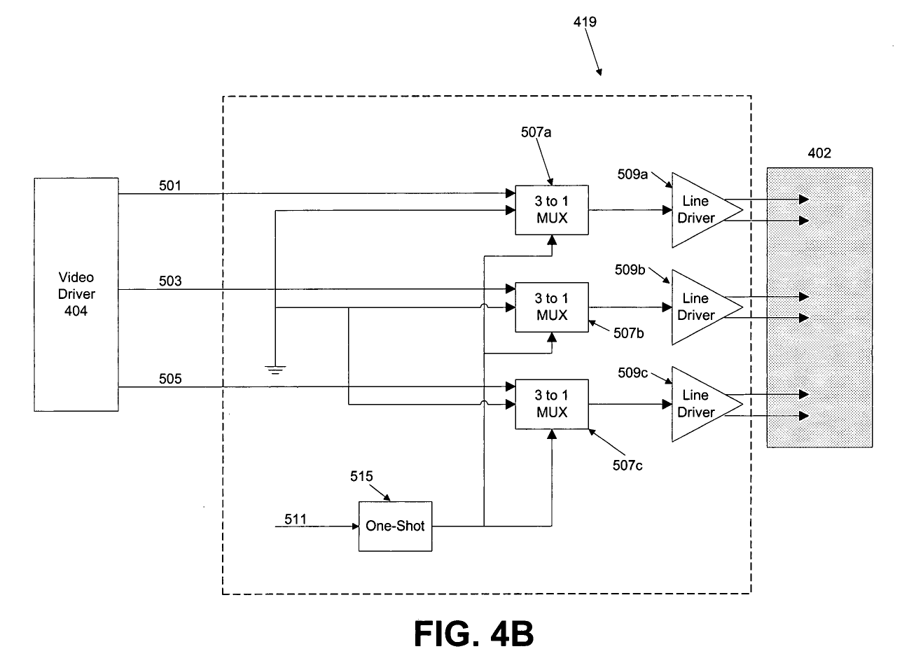

Turning next to FIG. 4A, shown is a block diagram of the internal structure of CIM 115 including signal injection port 400, port 402, video driver 404, CIM CPU 406, UART 408, memory 410, and signal injection circuit 419. CIM 115 interfaces video monitor port 412, keyboard port 414 and cursor control device port 416 of remote computer 117 to MSU 111 via cable 418 and port 400. During normal operation, CIM 115 transmits video signals unidirectionally from remote computer 117 to MSU 111. Keyboard and cursor control device signals may be transmitted bi-directionally between remote computer 117 and MSU 111.

During operation, video signals are transmitted from video monitor port 412 of remote computer 117 to port 400 of CIM 115 via cable 418. From port 400, the unidirectional video signals are transmitted to video driver 404 which converts the standard red, green and blue components of the video signal to differential signals for transmission through signal injection circuit 419 and port 402 to MSU 111 via cable 113. Each component of the video signal (i.e., red, green, and blue) is transmitted via its own twisted pair of wires contained within cable 113 (when transmitted from CIM 115 to MSU 111) or cable 109 (when transmitted from MSU 111 to UST 101) (FIG. 1). Furthermore, video driver 404 appends the horizontal and vertical synchronization signals each to one of the red, green or blue components of the video signal to allow all five components of the video signal to be transmitted via only three twisted pair of wires of cables 109 or 113. Preferably, the horizontal and vertical synchronization signals are each transmitted on its own color signal—not the same color signal.

Keyboard and cursor control device signals received from keyboard port 414 and cursor control device port 416, respectively, are transmitted via cable 418 to port 400, whereupon they are transmitted to CIM CPU 406. CIM CPU 406 creates data packets based upon the information contained in the received signals generated by the local UST 101 that has requested access to the remote computer attached to CIM 115. Thereafter, the newly generated signals representing the data packets are transmitted to UART 408, which serializes the signals and transmits them via cable 113 to MSU 111 through port 402.

Keyboard and cursor control device signals received from MSU 111 via cable 113 are received via port 402 and de-serialized by UART 408. UART 408 then transmits the keyboard and cursor control device signals to CIM CPU 406 which uses the information contained in the signals to emulate the keyboard and cursor control device signals generated by keyboard 103 and cursor control device 107. These emulated signals are applied to keyboard port 414 and cursor control device port 416 through port 400 via cable 418.

Furthermore, CIM 115 contains memory unit 410, which stores identification information for CIM 115 and its connected remote computer 117 including the assigned name, group, address, etc. Thus, if a specific remote computer 117 is not functioning properly, it is easy to assess which remote computer 117 has malfunctioned. In addition, the CIM address facilitates proper transmission of the keyboard and mouse signals since the address of the desired CIM 115 is included in the keyboard and mouse data packets that are generated by MSU CPU 312. For example, if CIM 115 receives a data packet containing the wrong address, the data packet may be returned to MSU CPU 312 for retransmission to the proper CIM 115. Furthermore, memory unit 410 allows CIM 115 and its connected remote computer 117 to be easily identified even if it is relocated and/or connected to a new MSU 112 or a new port of the same MSU 111. Upon reconnection of CIM 115, MSU 111 reads the identification information stored in the CIM's memory unit 410. This information allows MSU 112 to reconfigure or update the location of CIM 115, which ensures that the system continues to properly route information to CIM 115. This feature allows system administrators to easily re-organize CIMs 115 and remote computers 117 without re-programming the system.

In the preferred embodiment, remote computer 117 provides power to CIM 115. Thus, the equipment and cabling required for a dedicated CIM power source is eliminated saving space and money.

When a user of the user workstation elects to connect to a different remote computer 117, the system enters an automatic skew calibration mode. This causes CIM CPU 406 to direct signal injection circuit 419 to emit a pulse, which is transmitted through UART 408 where it is serialized and transmitted via cable 113 to MSU 111 through port 402.

As shown in FIG. 4B, signal injection circuit 419 comprises red transmission line 501, green transmission line 503, blue transmission line 505, multiplexers (“MUXs”) 507a, 507b, and 507c, line drivers 509a, 509b, and 509c, horizontal synchronization signal 511, and one-shot circuit 515. During normal operation, signal injection circuit 419 receives the red, green, and blue components of the video signal from video driver 404 through red transmission line 501, green transmission line 503, and blue transmission line 505, respectively. In normal operation, signal injection circuit 419 transmits the red, green, and blue components of the video signal through MUX 507a, 507b, and 507c, respectively, to line drivers 509a, 509b, and 509c, respectively. Each MUX 507a, 507b, and 507c is preferably a switch capable of routing two inputs to a single output (i.e., a 2 to 1 multiplexer). Line drivers 509a, 509b, and 509c convert each of the red, green, and blue components of the video signal into differential transmission signals for transmission over the twisted pairs 205a, 205b and 205c, respectively, of cable 113.

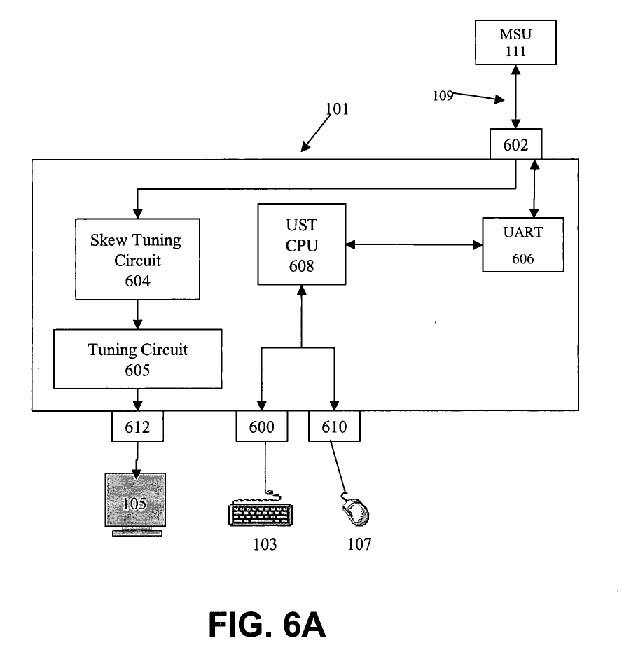

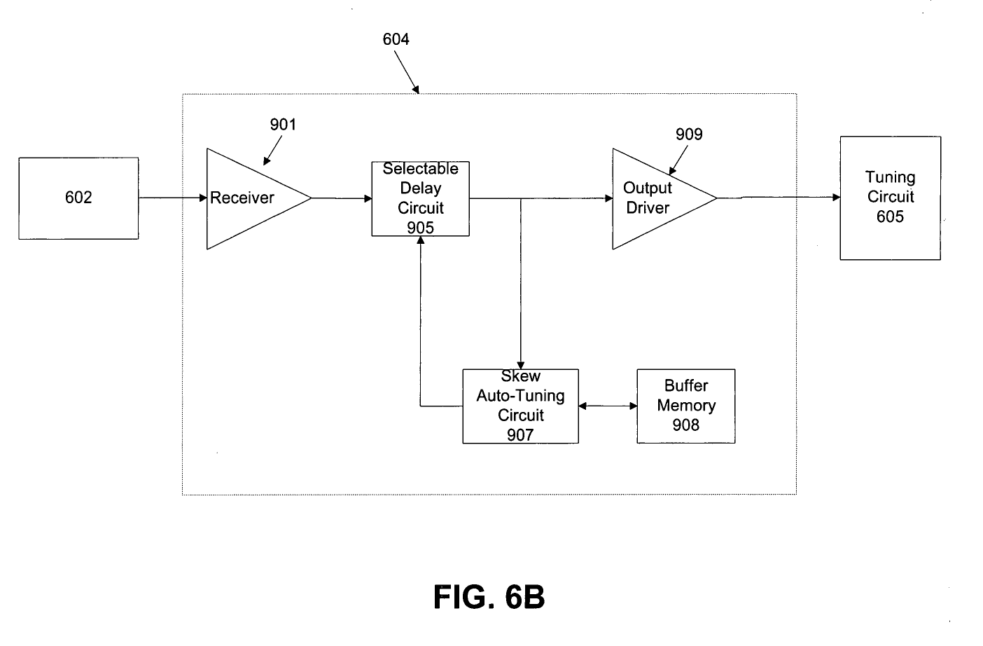

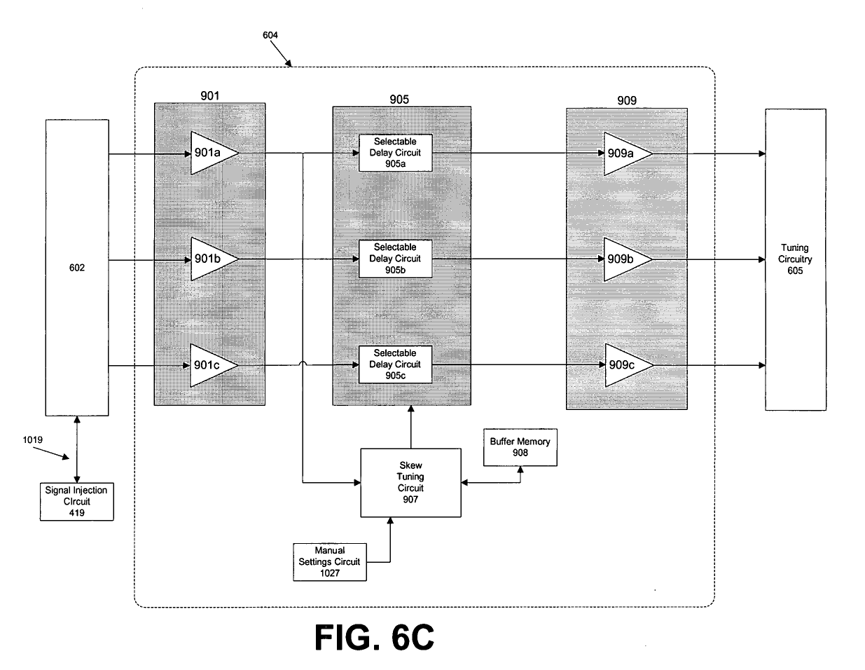

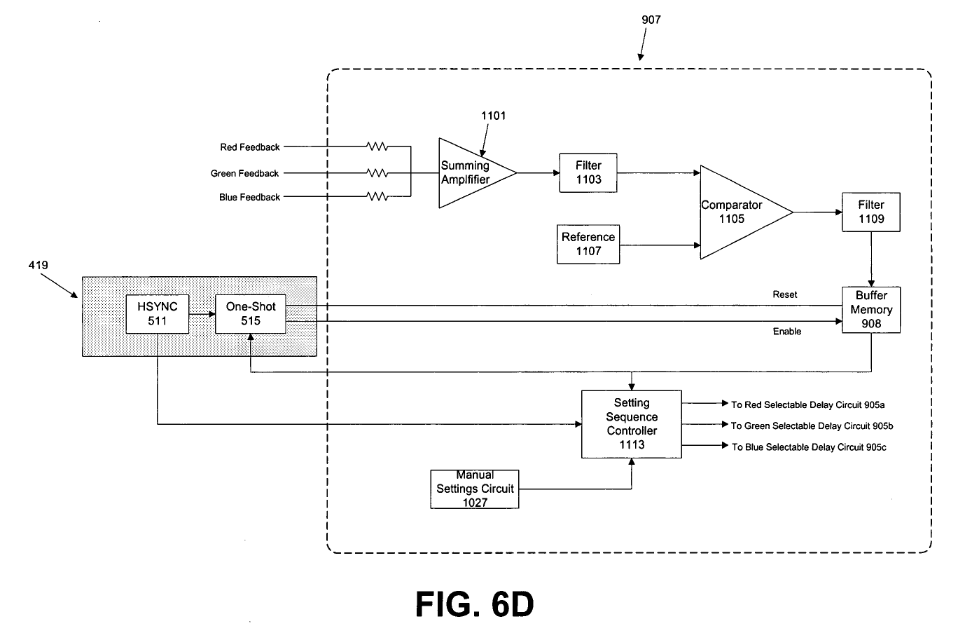

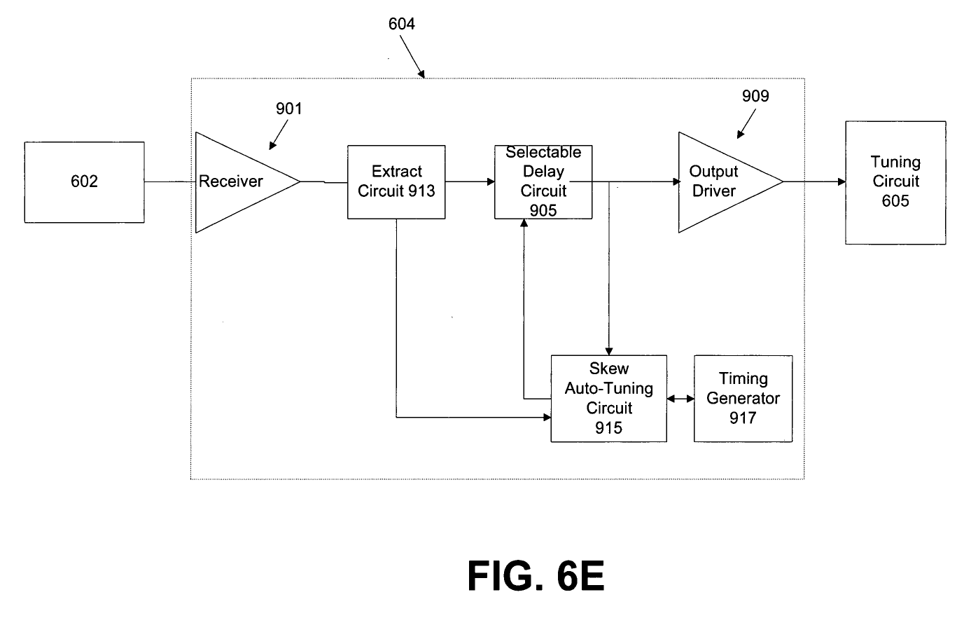

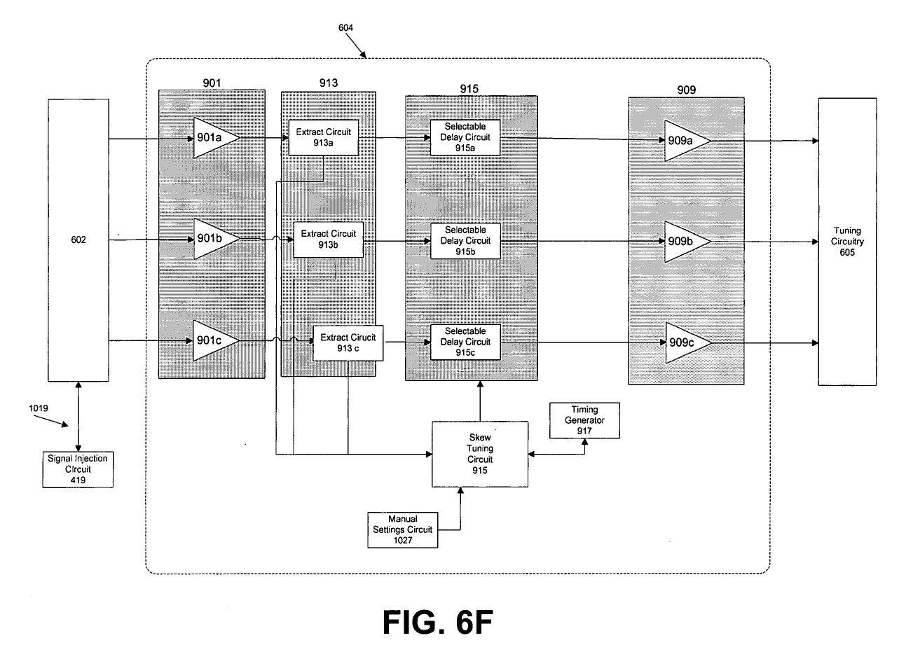

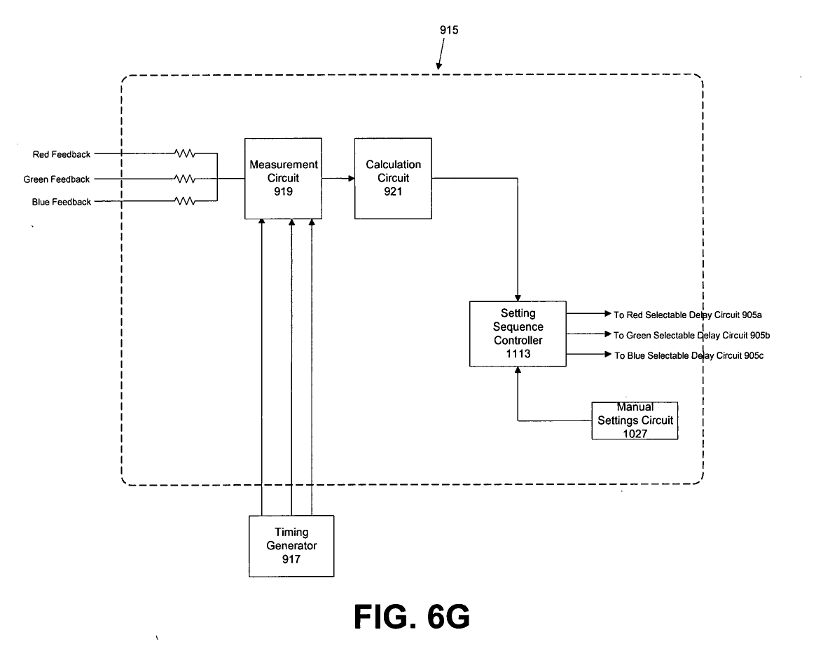

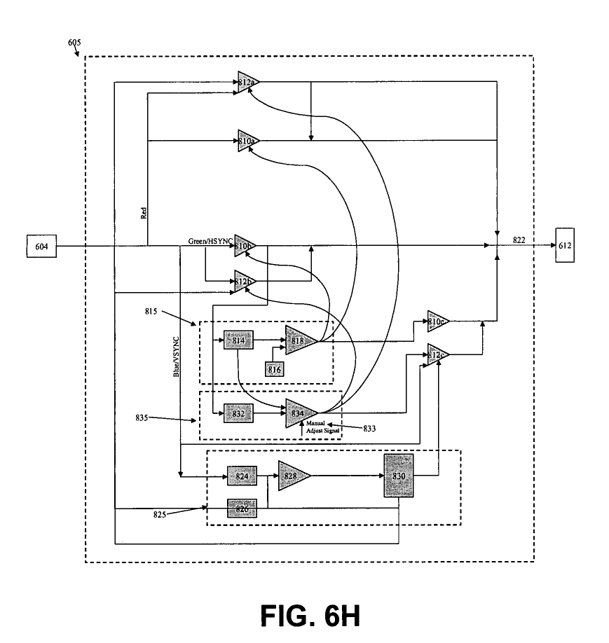

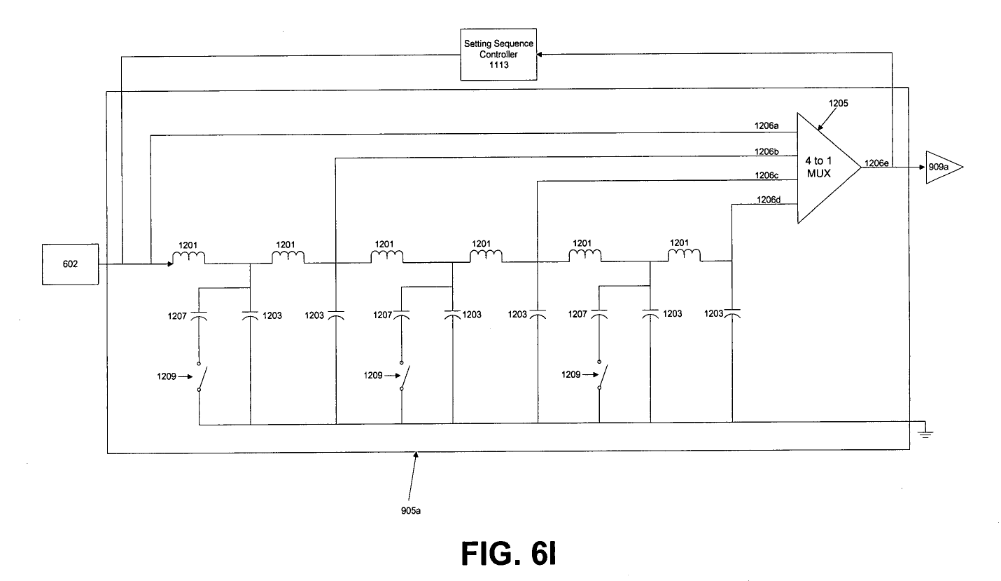

When a user requests to control a different remote computer 117, signal injection circuit 419 initiates an automatic skew calibration mode and instructs MUXs 507a, 507b, and 507c to temporarily suspend video transmission. Instead, each MUX 507a, 507b, and 507c transmits a pulse of known width and amplitude supplied by one-shot circuit 515. Preferably, the pulse is a single square wave pulse. Line drivers 509a, 509b, and 509c convert this pulse to a differential signal for transmission over twisted pairs 205a, 205b, and 205c of cable 113. The pulse arrives at MSU 111 and is then transmitted to the appropriate UST 109 via cable 109. Circuitry located in UST 109 then converts the pulse from a differential form to its original form. Skew compensation circuit 604 measures the skew of the received test pulses and applies the appropriate delay to each of the three twisted pair of wires configured to carry the red, green, and blue components of the video signal, thereby correcting for the separation of colors occurring at the video monitor 105 attached to UST 101. This is discussed in more detail below with respect to FIG. 6B.

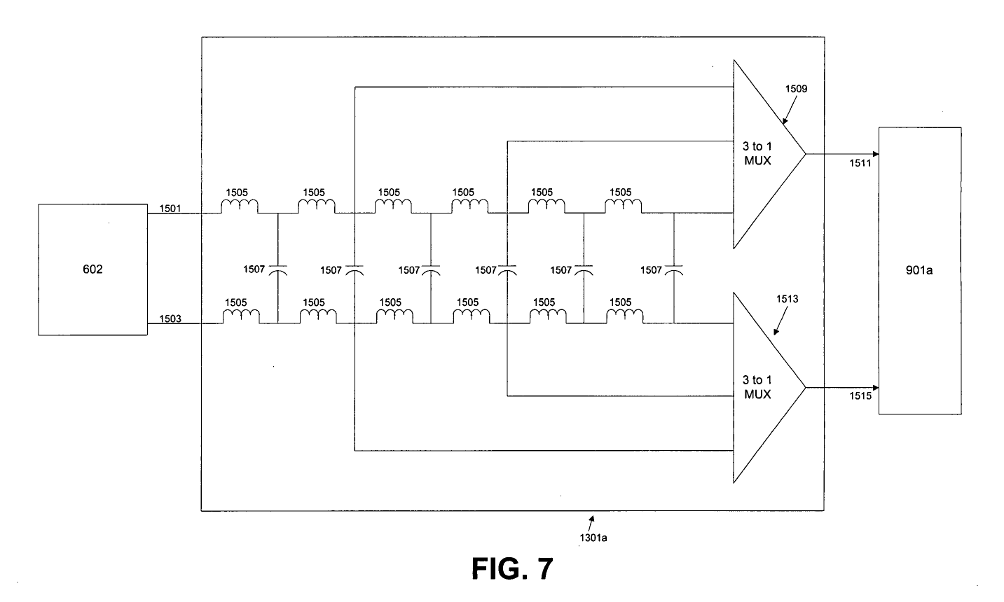

Alternatively, if skew compensation is to be performed without suspending video transmission, signal injection circuit 419 does not instruct MUXs 5076a, 507b, and 507c to stop video transmission. Instead, each MUX 507a, 507b, and 507c transmits a composite signal of the video and a reference pulse of known width and amplitude supplied by one-shot circuit 515. Preferably, the pulse is a single square wave pulse. Line driver 509a, 509b, and 509c convert this pulse to a differential signal for transmission over twisted pairs 205a, 205b, and 205c of cable 113. The signal arrives at MSU 111 and is then transmitted to the appropriate UST 109 via cable 109. Circuitry located in UST 109 then converts the signal from a differential form to its original form. Skew compensation circuitry extracts the test pulses from the composite signal and measures the skew of the received test pulses and applies the appropriate delay to each of the three twisted pair of wires configured to carry the red, green, an blue components of the video signal, thereby correcting for the separation of colors occurring at the video monitor 105 attacked to UST 101. This is discussed in more detail below with respect to FIG. 7E.

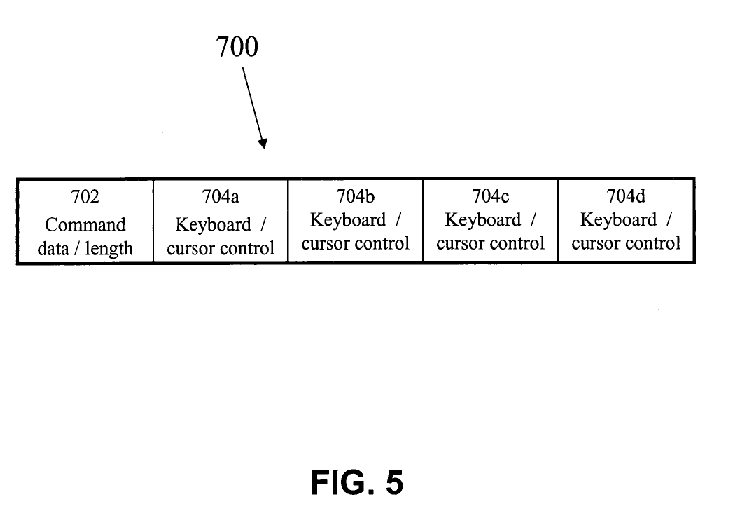

Now referring to FIG. 5, provided is an example of a data packet used to transmit keyboard and cursor control device information. As shown, protocol data packet 700 preferably consists of five bytes, although packets containing more or less bytes may also be used. First byte 702 comprises the instructional, or command, data and data regarding the total length of data packet 700. That is, the first half of first byte 702 contains the command data and the second half of first byte 702 contains the length data. The subsequent four bytes 704a, 704b, 704c, and 704d include the actual data for transmission, including characters typed on keyboard 103, clicks performed with cursor control device 107 (FIG. 1), etc;

The preferred embodiment of the present invention minimizes the size of the data packet by combining the command and length data into one byte, thereby allowing four bytes of system data to be transmitted in a five-byte data packet. Consequently, signal transmission is more efficient, allowing a single CAT 5 cable to be used for transmission of keyboard, cursor control device and video signals.

Turning next to FIG. 6A, depicted is a block diagram of the preferred embodiment of UST 101. UST 101 interfaces keyboard 103, video monitor 105 and cursor control device 107 (although additional and/or other peripheral devices may also be used) with MSU 111 for connection to any of a plurality of remote computers 117 (FIG. 1). Keyboard 103, video monitor 105, and cursor control device 107 are preferably connected to keyboard port 600, video port 612, and cursor control device port 610 of UST 101, respectively, using industry standard connectors and cabling. For example, the keyboard and cursor control device may be connected utilizing PS/2 connectors, serial connectors, Universal Serial Bus connectors, etc. Monitors are typically connected to a computer through a DB9 port. UST CPU 608 receives the keyboard and cursor control device signals generated by keyboard 103 and cursor control device 107, respectively, at the local user workstation via keyboard port 600 and cursor control device port 610, respectively. UST CPU 608 creates data packets representative of the keyboard and cursor control device information from the received keyboard and cursor control device signals. Thereafter, the newly generated data packets, which utilize the data packet structure of protocol data packet 700 (FIG. 5), are transmitted to UART 606, where the data packets are converted to a serial format and transmitted through port 602 to MSU 111 via cable 109. MSU 111 then sends the data packets to the selected remote computer 117 via cable 113 and CIM 115 (FIG. 1).

As previously discussed keyboard and cursor control device signals are transmitted bidirectionally in the remote management system. That is, not only are these signals transmitted from the user workstation to the remote computer, but are also transmitted form the remote computer to the user workstation. In this direction of transmission (i.e., remote computer to user workstation), keyboard and cursor control device signals are received from MSU 111 via cable 109 at port 602 which is coupled to UART 606 and to UST CPU 608, which uses the information contained in the signal to emulate the keyboard and cursor control device signals from remote computer 117. These emulated signals are applied to keyboard 103 and cursor control device 107 via keyboard port 600 and cursor control device port 610, respectively.

Unidirectional video signals are also received at port 602 from MSU 111 via cable 109. However, these video signals are not transmitted to UART 606, but rather are transmitted to skew compensation circuit 604, which applies an appropriate signal delay to the red, green, and blue components of the video signal to correct for any color separation. As shown in FIG. 6B, the preferred embodiment of skew compensation circuit 604 includes receiver 901, selectable delay circuit 905, skew tuning circuit 907, buffer memory 908, and output driver 909. In general, during operation, the red, green and blue components of the video signal are each transmitted to receiver 901 which converts the different components of the video signal back to their original form. The red, green, and blue components of the video signal are then transmitted to selectable delay circuit 905 which applies the appropriate delay to the red, green, and blue components of the video signal as determined by skew tuning circuit 907. Finally, the compensated video signal is transmitted by output driver 909 to tuning circuitry 605 which compensates for signal degradation (e.g., high frequency attenuation) which occurs when video signals are transmitted over long distances utilizing cabling containing twisted pairs of wires, such as CAT 5 cabling.

As previously mentioned, when a user of the workstation elects to connect to a different remote computer, the system of the present invention enters an automatic skew calibration mode. In this mode, a pulse is injected into cable 113 by one-shot circuit 515 (FIG. 4B) located in CIM 115 (FIG. 4A). A pulse is injected simultaneously onto each of the three twisted pairs used to transmit the red, green, and blue components of the video signal. Preferably, each pulse is a single square wave pulse of known frequency and amplitude. The pulses are received at skew compensation circuit 604 from port 602. The pulses are initially converted from differential form to their original form by receiver 901. The pulses then pass from selectable delay circuit 905 to skew tuning circuit 907.

In the preferred embodiment of compensating for the separation of colors, skew tuning circuit 907 sums the amplitude of the three incoming injection pulses and compares the summed amplitude to a predetermined reference amplitude. This summed amplitude is recorded in buffer memory 908. Preferably, skew tuning circuit 907 cycles selectable delay circuit 905 through all possible delay combinations and records all the summed amplitudes in buffer memory 908. The delay configuration which produced a summed amplitude closest to the reference amplitude is then selected by skew tuning circuitry 907 from buffer memory 908 for implementation in selectable delay circuit 905. After selectable delay circuit 905 has been properly set, the system exits the automatic skew calibration mode and assumes normal video transmission as previously described.

Referring next to FIG. 6C, depicted is an enhanced block diagram of skew compensation circuit 604 of FIGS. 6A-6B. In general, during operation, the red, green, and blue differential video signals are transmitted to skew compensation circuit 604. In skew compensation circuit 604, the red, green, and blue components of the video signal are initially converted from a differential form to their original form by red receiver 901a, green receiver 901b, and blue receiver 901c, respectively. The converted red, green, and blue components of the video signal are then supplied to selectable delay circuit 905 which is controlled by skew tuning circuit 907. Selectable delay circuit 905 contains red selectable delay circuit 905a, green selectable delay circuit 905b, and blue selectable delay circuit 905c which apply the appropriate signal delay to the red, green, and blue components of the video signal, respectively, as determined by skew tuning circuit 907. Red selectable delay circuit 905a, green selectable delay circuit 905b, and blue selectable delay circuit 905c each contain a number of delay circuits which produce a known delay. Skew tuning circuit 907 utilizes these delay circuits in different combinations to produce the required delay in selectable delay circuit 905. Delay circuits 905a, 905b, and 905c are preferably inductor capacitor (“LC”) delay circuits which simulate an extended transmission line as shown in FIG. 6I. However, other known delay circuits capable of producing a known signal delay may also be used.

Selectable delay circuit 905 contains red selectable delay circuit 905a, green selectable delay circuit 905b, and blue selectable delay circuit 905c. However, each selectable delay circuit 905a, 905b, and 905c preferably consist of identical circuitry. The circuit for only red selectable delay circuit 905a is shown and described with reference to FIG. 6I, but it applies equally for green selectable delay circuit 905b, and blue selectable delay circuit 905c. As shown, the pulse or video signal arrives at red selectable delay circuit 905a from port 602 and is output from red selectable delay circuit 905a to red output driver 909a.

As depicted in FIG. 6I, red selectable delay circuit 905a preferably consists of a series of inductors 1201, capacitors 1203, LC multiplexer (“MUX”) 1205, selectable capacitors 1207, and switches 1209. The properties of inductors 1201 and capacitors 1203 are predetermined to provide the required signal delay. Thus, the selectable delay circuitry comprises selectable LC circuits which produce a known and deterministic delay based on the capacitance and inductance of its components as is well known to one skilled in the art of circuit design. Of course, many different LC combinations may be chosen utilizing LC MUX 1205. LC MUX 1205 contains four inputs 1206a, 1206b, 1206c, and 1206d and a single output 1206e and is controlled by setting sequence controller 1113. The four inputs, 1206a, 1206b, 1206c, and 1206d, may be combined in any manner into single output 1206e utilizing LC MUX 1205 to provide the required signal delay. For example, suppose each LC delay circuit consisting of at least one inductor 1201 and at least one capacitor 1203 produce a six (6) nanosecond delay. The four LC MUX inputs 1206a, 1206b, 1206c, and 1206d may be combined to produce up to a twenty-four (24) nanosecond delay. Additionally, suppose that setting sequence controller 1113 has determined that a twelve (12) nanosecond delay is required for optimum skew compensation. To provide the required delay, LC MUX 1205 may combine inputs 1206a and 1206b while terminating inputs 1206c and 1206d resulting in a twelve (12) nanosecond delay.

Red selectable delay circuit 905a additionally contains selectable capacitors 1207 in series with switches 1209 and in parallel with capacitors 1203. Setting sequence controller 1113 utilizes switches 1209 to enable or disable selectable capacitors 1207, thereby producing yet additional signal delay control. For example, by closing any switch 1209, selectable capacitors 1207 add additional capacitance to each LC delay circuit, thereby producing an additional controllable signal delay. Thus, red selectable delay circuit 905a allows for a total of sixteen (16) possible delays (including a delay of zero) utilizing different combinations of inductors 1201, capacitors 1203, and selectable capacitors 1207 with LC MUX 1205 and switches 1209 under the control of setting sequence controller 1113. However, the number of selectable LC delay circuits utilized in red selectable delay circuit 905a may be varied by changing the number of inductors 1201, capacitors 1203, capacitors 1207, and switches 1209, and using an LC MUX 1205 with more than four (4) inputs. As described, it is preferred that green selectable delay circuit 905b and blue selectable delay circuit 905c are similarly constructed.

After the appropriate signal delays have been applied to the red, green, and blue components of the video signal by selectable delay circuit 905, the video signal is supplied to output driver 909. Output driver 909 comprises red output driver 909a, green output driver 909b, and blue output driver 909c which transmit the red, green, and blue components of the video signal, respectively, to tuning circuitry 605. As shown in FIG. 6H, tuning circuitry 605 preferably comprises red variable gain amplifier 810a, green variable gain amplifier 810b, blue variable gain amplifier 810c, red frequency compensation amplifier 812a, green frequency compensation amplifier 812b, blue frequency compensation amplifier 812c, slow peak detector 814, voltage source 816, comparator 818, slow peak detector 824, voltage source 826, comparator 828, video switch 830, fast peak detector 832, and comparator 834.

During operation, the keyboard, video, and cursor control device signals from remote computer 117 are transmitted via cable 418 to CIM 115 (FIGS. 1 and 4A). Thereafter, the video signals and data packets generated by CIM CPU 406 are transmitted from CIM 115 to MSU 111 via cable 113 (FIGS. 1 and 4A). At this point in the video signal transmission, the video signal may be greatly distorted (e.g., the high frequency components of the signal may be greatly attenuated). Therefore, tuning circuitry 605 is implemented to automatically tune the received signals to achieve the desired amplitude and frequency. Subsequently, the video signal and the signals generated by MSU CPU 312 (FIG. 2) are transmitted from MSU 111 to UST 101, wherein the video signal is conditioned by tuning circuitry 605.

In the preferred embodiment, the horizontal synchronization signal is encoded on and transmitted with the green video signal, and the vertical synchronization signal is encoded on and transmitted with the blue video signal. However, it is known to one of ordinary skill in the art that the horizontal and vertical synchronization signals may be encoded on and transmitted with any one of the red, green, or blue video signals. Preferably, the horizontal and vertical synchronization signals are encoded as negative pulses, since the video signals (i.e., red, green, and blue) are preferably positive pulses.

Tuning circuitry 605 contains three dedicated signal adjustment circuits (i.e., one for each of the red, blue, and green video color signals), a gain amplification adjustment circuit 815, a frequency compensation amplification adjustment circuit 835, and an additional filtering enablement circuit 825.

In operation, the red component of the video signal is initially transmitted to red variable gain amplifier 810aand red variable frequency compensation amplifier 812a. Preferably, red variable gain amplifier 810aadjusts the amplitude of the red component of the video signal based upon the output of gain amplification adjustment circuit 815. Concurrently, red variable frequency compensation amplifier 812a adjusts the frequency of the red component of the video signal based upon the output of frequency compensation amplification adjustment circuit 835. The outputs of red variable gain amplification circuit 810aand red frequency compensation circuit 812a are electrically combined and transmitted via wire 822 to skew compensation circuit 604.

The green component of the video signal, with the encoded horizontal synchronization signal, is initially transmitted to green variable gain amplifier 810b and green variable frequency compensation amplifier 812b. The two outputs are then electrically combined and transmitted to gain amplification adjustment circuit 815 and frequency compensation amplification adjustment circuit 835. Gain amplification circuit 815 comprises slow peak detector 814 that receives the electrically combined outputs of green variable gain amplifier 810b and green variable frequency compensation amplifier 812b. Slow peak detector 814 detects the amplitude of the horizontal synchronization signal, which is encoded on the green component of the video signal, and transmits a signal representing this amplitude to comparator 818 and comparator 834. Comparator 818 then compares the signal received from slow peak detector 814 to a constant reference voltage supplied by voltage source 816. The signal supplied by voltage source 816 represents the desired amplitude for the horizontal synchronization signal. Next, comparator 818 transmits a signal to red variable gain amplifier 810a, green variable gain amplifier 810b, and blue variable gain amplifier 810c to adjust the level of amplification of the red, green, and blue components of the video signal until the desired amplitude is achieved.

Similarly, green variable frequency compensation amplifier 812b adjusts the level of amplification of the frequency of the horizontal synchronization signal based upon the output of frequency compensation amplification adjustment circuit 835. Frequency compensation amplification adjustment circuit 835 comprises fast peak detector 832 that also receives the electrically combined outputs of green variable gain amplifier 810b and green variable frequency compensation amplifier 812b. Fast peak detector 832 detects the rising edge of the horizontal synchronization signal and transmits a signal representing this rising edge to comparator 834. Then, comparator 834 compares the signal received from fast peak detector 832 to the output of slow peak detector 814 to compare the amplitude of the rising edge of the horizontal synchronization signal pulse to the amplitude of the horizontal synchronization signal pulse itself. Next, comparator 834 sends a signal that is fed to red variable frequency compensation amplifier 812a, green variable frequency compensation amplifier 812b, and blue variable frequency compensation amplifier 812c to adjust the level of amplification of the red, green, and blue components of the video signal until the desired signal characteristics are achieved. Optionally, the signal transmitted by comparator 834 may be manually adjusted using manual input 833 by a system user (e.g., via the on-screen display discussed above). Such a feature would allow the system user to manually “tweak” the gain of the video signals until a desired video output is achieved.

The blue component of the video signal, along with the encoded vertical synchronization signal, is initially transmitted to blue variable gain amplification circuit 810c, blue variable frequency compensation circuit 812c, and filtering enablement circuit 825, which is employed to increase the range of red variable frequency compensation amplifier 812a, green variable frequency compensation amplifier 812b, and blue variable frequency compensation amplifier 812c when the video signals have been transmitted over approximately four hundred fifty (450) feet. The vertical synchronization signal, which is encoded on the blue component of the video signal as a precise square wave signal of known duration and amplitude, is used as a precise reference point for filtering enablement circuit 825. The blue component of the video signal and the encoded vertical synchronization signal are received by slow peak detector 824, which detects the amplitude of the vertical synchronization signal. Slow peak detector 824 transmits a signal representing the amplitude of the vertical synchronization signal to comparator 828, which compares it to the known amplitude of a similar signal transmitted for four hundred fifty (450) feet. This known amplitude is represented by a constant reference voltage applied to comparator 828 by voltage source 826. If comparator 828 determines that the vertical synchronization signal (and therefore all of the video signals) have been transmitted over four hundred fifty (450) feet, a signal indicating this is transmitted to video switch 830. Video switch 830 then sends a signal to red variable frequency compensation amplifier 812a, green variable frequency compensation amplifier 812b, and blue variable frequency compensation amplifier 812c to increase the range of each frequency compensation amplifier 812a, 812b, and 812c. Subsequent to gain amplification by gain amplification adjustment circuit 815 and frequency compensation by frequency compensation amplification adjustment circuit 835, the conditioned red, green, and blue components of the video signal are transmitted to video port 612.

Referring back to FIG. 6C, once a user requests to be switched to a different remote computer, the system again enters the skew calibration mode. As previously described, a pulse is injected by signal injection circuit 419 (FIG. 4A). The injection pulses are initially sent to skew compensation circuit 604, where they are supplied to selectable delay circuit 905. Each selectable delay circuit 905a, 905b, and 905c is independently adjusted by skew tuning circuit 907. Skew tuning circuit 907 then cycles the delay circuits located in red selectable circuit delay 905a, green selectable circuit delay 905b, and blue selectable circuit delay 905c through all possible delay combinations and records the summed pulse amplitude in buffer memory 908 for each delay combination in the cycle. After each delay combination has been tested, each summed amplitude is compared to a predetermined reference amplitude. The delay configuration which produced a summed amplitude closest to the reference amplitude is then selected by skew tuning circuitry 907 from buffer memory 908 for implementation in selectable delay circuit 905. The reference signal is equivalent to the summation of three synchronized pulses (i.e., a single pulse with ripple the amplitude of an individual pulse). Therefore, by searching for a delay that results in a signal that matches that reference pulse, the system of the present invention is looking for the delay that best synchronizes the signals.

Once the best selectable delay has been chosen, skew tuning circuit 907 sends a termination signal 1019 to signal injection circuit 419 indicating that automatic skew calibration has been completed. Optionally, skew tuning circuit 907 contains manual override circuit 1027 which allows a user of the system to override the automatic skew calibration to perform manual calibration, if desired. Referring next to FIG. 6D, shown is a detailed block diagram of the preferred skew tuning circuit 907 depicted in FIGS. 6B-6C. During the automatic skew calibration mode, skew tuning circuit 907 receives the pulses encoded on the red, green, and blue video signal transmission lines at summing amplifier 1101. Here, the three pulses are combined into a single signal, which is then processed by filter 1103 to eliminate noise and transmitted to comparator 1105.

Comparator 1105 compares the combined signal pulse to a reference pulse stored in reference 1107. Reference 1107 may be any device capable of providing a reference amplitude, such as a voltage source, random access memory, flash memory, etc. In the preferred embodiment, comparator 1105 outputs the difference between the amplitude of the combined signal pulse and the reference pulse. The difference is processed by comparator filter 1109 and the resulting difference is stored in buffer memory 908.

After receiving the difference information, buffer memory 908 sends a reset signal to one-shot circuit 515 located in signal injection circuit 419 directing it to produce another pulse. Concurrently, setting sequence controller 1113 implements the next delay combination of delay circuits in red selectable delay circuit 905a, green selectable delay circuit 905b, and blue selectable delay circuit 905c. The entire process is repeated for the next pulse signal until all possible delay combinations have been tested. Setting sequence controller 1113 utilizes the stored amplitude differences contained in buffer memory 908 to select the delay combination which produced a summed signal amplitude most closely matching the amplitude of the pulse stored in reference 1107. Once the appropriate delay combination has been determined, setting sequence controller 1113 implements this delay combination by correctly adjusting selectable delay circuit 905 and sends a signal to one-shot circuit 515 directing it to stop transmitting pulses in order that the system may resume normal video transmission. Setting sequence controller 1113 may be any device or circuit capable of controlling selectable delay circuit 905 utilizing the information stored in buffer memory 908.

Setting sequence controller 1113 may optionally include manual override circuit 1027 which allows a user workstation to manually select a delay combination for red selectable delay circuit 905a, green selectable delay circuit 905b, and blue selectable delay circuit 905c. A user may require manual override control of the system in any situation in which manual skew calibration is necessary.

FIGS. 6E-6G depict an alternate embodiment of skew compensation circuit 604. In this embodiment, it is not necessary for the system to interrupt the transmission of video signals for calibrating the compensation of skew. Instead, the test pulses are sent with the video signals as composite signals, and the time difference between the receipt of each test pulse on the three twisted pairs is measured. The time difference measured is then utilized to select the appropriate delay to be applied to the red, green and blue signals. Although a different method of determining best delay is utilized in this embodiment, the same selectable delay circuit 905 can be utilized to implement the delay.

As shown in FIG. 6E, the alternate embodiment of skew compensation circuit 604 includes receiver 901, selectable delay circuit 905, extract circuit 913 skew auto-tuning circuit 915, timing generator circuit 917, and output driver 909. In general, during operation, the red, green and blue components of the video signal are each transmitted to receiver 901 which converts the different components of the video signal back to their original form. The red, green, and blue components of the video signal are then transmitted to selectable delay circuit 905 which applies the appropriate delay to the red, green, and blue components as determined by skew auto-tuning circuit 915. Finally, the compensated video signal is transmitted by output driver 909 to tuning circuitry 605 which compensates for signal degradation (e.g., high frequency attenuation) which occurs when video signals are transmitted over long distances utilizing cabling containing twisted pairs of wires, such as CAT 5 cabling.

In this embodiment, when the user switches to a different remote computer, or after a period of time has elapsed (e.g., 20 seconds) since the previous calibration, the system sends and receives a test pulse with each of the red, green and blue signals. Preferably, each test pulse is a single square wave pulse of known frequency and amplitude sent with the video signal as a composite signal (e.g., using a method similar to that of combining the sync signals with the video on a single twisted pair). The composite video is received at skew compensation circuit 604 from port 602. The composite signal is initially converted from differential form into its original form by receiver 901. Then, extract circuit 913 removes the test pulses, which are provided to skew auto-tuning circuit 915. The video signals, also extracted from extract circuit 913 are supplied to selectable delay circuit 905.

In this embodiment of compensating for the separation of colors, skew auto-tuning circuit 915 utilizes timing generator circuit 917 to determine the latency of each test pulse relative to the test pulse received first (e.g., skew auto-tuning circuit 915 could determine if green test pulse was received 4 nanoseconds after the blue test pulse). This time determination is then utilized by skew auto-tuning circuitry 915 for implementation in selectable delay circuit 905.

Referring next to FIG. 6F depicted is an enhanced block diagram of the alternate embodiment of skew compensation circuit 604 of FIGS. 6A, and 6E. In general, during operation, the red, green, and blue differential video signals are transmitted to skew compensation circuit 604. In skew compensation circuit 604, the red, green, and blue components of the video signal are initially converted from a differential form to their original form by red receiver 901a, green receiver 901b, and blue receiver 901c, respectively. The converted red, green, and blue components of the video signal are then supplied to selectable delay circuit 905 which is controlled by skew auto-tuning circuit 915. Selectable delay circuit 905 contains red selectable delay circuit 905a, green selectable delay circuit 905b, and blue selectable delay circuit 905c which apply the appropriate signal delay to the red, green, and blue components of the video signal, respectively, as determined by skew auto-tuning circuit 915. Red selectable delay circuit 905a, green selectable delay circuit 905b, and blue selectable delay circuit 905c each contain a number of delay circuits which produce a known delay as discussed above. Skew auto-tuning circuit 915 utilizes these delay circuits in different combinations to produce the required delay in selectable delay circuit 905. Delay circuits 905a, 905b, and 905c are preferably inductor capacitor (“LC”) delay circuits which simulate an extended transmission line as discussed above with reference to FIG. 6I. However, other known delay circuits capable of producing a known signal delay may also be used.

After the appropriate signal delays have been applied to the red, green, and blue components of the video signal by selectable delay circuit 905, the video signal is supplied to output driver 909. Output driver 909 comprises red output driver 909a, green output driver 909b, and blue output driver 909c which transmit the red, green, and blue components of the video signal, respectively, to tuning circuitry 605 which was discussed above with reference to FIG. 6H.

As described, in this alternate embodiment, the injected pulses are sent with the video signals to skew compensation circuit 604 where the pulses are extracted by extract circuits 913a, 913b and 913c and fed to skew auto-tuning circuit 915. The video signals, also extracted by extract circuits 913a, 913b, and 913c are supplied to selectable delay circuits 905a, 905b, and 905c which are each independently adjusted by skew auto-tuning circuit 915. Skew auto-tuning circuit 915 utilizes timing generation circuit 917 to determine the delay between receiving the test pulse on the shortest wire and on the other two wires. As in the preferred embodiment, skew auto-tuning circuit 915 optionally interfaces with manual override circuit 1027 which allows a user of the system to override the automatic calibration to perform manual calibration, if desired.

Referring next to FIG. 6G, shown is a detailed block diagram of the skew auto-tuning circuit 915 depicted in FIGS. 6E-6F. When the skew is calibrated, skew auto-tuning circuit 915 receives the pulses encoded on the red, green, and blue video signal transmission lines from extract circuits 913a, 913b, and 913c at measurement circuit 919. Measurement circuit 919, utilizing data from timing generator 917 determines the times at which the test pulses arrive on each of the red, green and blue signal transmission lines. Calculation circuit 921 then determines the difference between the times at which the test pulses arrived. Timing generator circuit 917 may utilize digital delay line technology in the generation of timing signals. Calculation circuit 921 may determine the timing differences in the test pulses by a logic comparison of the test pulses with timing signals generated by timing generator circuit 917. The delay computed from calculation circuit 921 is provided to setting sequence controller 1113 which implements the best delay combination by correctly adjusting selectable delay circuit 905. Setting sequence controller 1113 may be any device or circuit capable of controlling selectable delay circuit 905 utilizing the information provided by calculation circuit 921.

Setting sequence controller 1113 may optionally include manual override circuit 1027 which allows a user workstation to manually select a delay combination for red selectable delay circuit 905a, green selectable delay circuit 905b, and blue selectable delay circuit 905c. A user may require manual override control of the system in any situation in which manual skew calibration is necessary.

Now referring to FIG. 7, shown is a schematic diagram of an alternate embodiment of selectable delay circuit 905. In contrast to the selectable delay circuit of FIG. 6I, the selectable delay circuit depicted in FIG. 7 is capable of accommodating a differential signal. Therefore, in this embodiment, receiver 901 can be located after selectable delay circuit 905. Again, only the circuitry of red selectable delay circuit 1301a is described, but it applies equally for green selectable delay circuit 1301b and blue selectable delay circuit 1301c. As shown, the red component of the video signal or the incoming test pulse arrives at red selectable delay circuit 1301a from port 602. In red selectable delay circuit 1301a, the positive component of the differential signal is received at positive input 1501 and the negative component of the differential signal is received at negative input 1503. A series of inductors 1505 in parallel with six capacitors 1507 provide a total of six selectable LC delay circuits; three for positive input 1501 and three for negative input 1503.

Positive MUX 1509 has a total of three inputs and one output. Each input is connected to two LC delay circuits. Positive MUX 1509 is capable of combining any of its inputs into a single positive output 1511 to provide the required signal delay. In a similar manner, negative MUX 1513 is capable of combining any of its three inputs into a single negative output 1515. Positive output 1511 and negative output 1515 are both connected to red receiver 1303a.

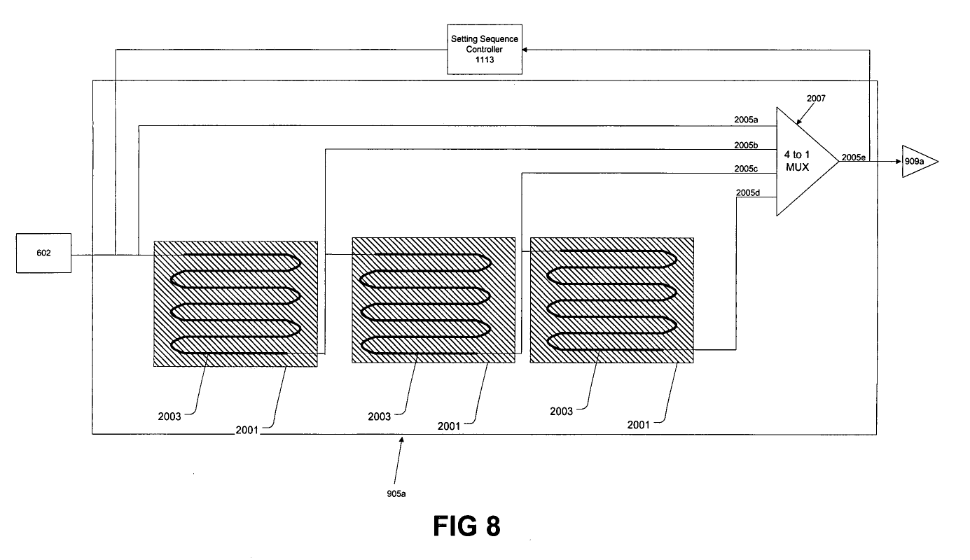

FIG. 8 depicts an alternate embodiment for red selectable delay circuit 905a in which traces on a circuit board are utilized to implement delay. Again, although only red selectable delay circuit 905a is shown in FIG. 8, it applies equally for green selectable delay circuit 905b, and blue selectable delay circuit 905c. As shown, the pulse or video signal arrives at red selectable delay circuit 905a from port 602 and is output from red selectable delay circuit 905a to red output driver 909a.

As depicted in FIG. 8, this alternate embodiment of red selectable delay circuit 905a preferably consists of a series of printed circuit boards 2001, each with snake traces 2003, with outputs connected to printed circuit board multiplexer (“PCB MUX”) 2007. The properties of the snake traces 2003 on printed circuit boards 2001 are predetermined to provide a required signal delay. Thus, the selectable delay circuitry comprises selectable printed circuit board traces which produce a known and deterministic delay based on the length of snake trace 2003. PCB MUX 2007 contains four inputs 2005a, 2005b, 2005c and 2005d and a single output 2005e and is controlled by setting sequence controller 1113. Each of the four inputs 2005a, 2005b, 2005c and 2005c connects zero, one, two and three of printed circuit boards 2001, thus providing different delays. PCB MUX, under control of setting sequence controller 1113 selects one of these outputs (and thus determines the delay of the signal). The delayed signal is then output to output driver 909a.

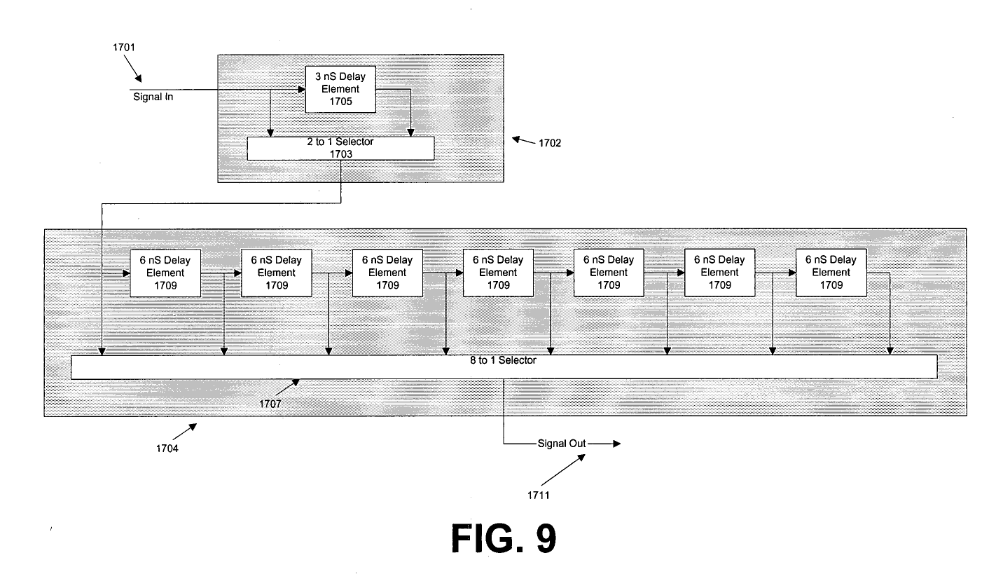

Now referring to FIG. 9, shown is a block diagram of yet another alternate embodiment of a selectable delay circuit according to the present invention. In this embodiment, the pulse or video signal initially enters fine selectable delay circuit 1702 via signal input 1701. Fine selectable delay circuit 1702 comprises fine delay element 1705 and fine selector 1703. Fine selector 1703, preferably a two-to-one multiplexer, is utilized to either enable or disable fine delay element 1705. For example, if fine selector 1703 opens its first input and closes its second input, the inputted signal (i.e., a test pulse or a video signal) bypasses delay element 1705 and fine selectable delay circuit 1702 provides no signal delay. However, if fine selector 1703 closes its first input and opens its second input, the inputted signal is transmitted through fine delay element 1705 which preferably applies a three nanosecond delay to the inputted signal. Fine delay element 1705 may be an LC delay circuit, a printed circuit board, or any other circuitry capable of implementing the preferred signal delay. In this embodiment, fine delay element 1705 provides a three nanosecond signal delay, although other delays may also be used.

After the inputted signal has been transmitted through fine selectable delay circuit 1702, the inputted signal is then transmitted to coarse selectable delay circuit 1704 which comprises coarse delay elements 1709a-1709g and coarse selector 1707. In this described embodiment, each coarse delay element 1709a-1709g provides a six nanosecond signal delay, although other delays may also be used. Coarse selector 1707, preferably an eight-to-one multiplexer, is utilized to either enable or disable coarse delay elements 1709a-1709g. For example, to implement a twelve nanosecond delay-utilizing coarse selectable delay circuit 1704, coarse selector 1707 would open its third input and close all other inputs. This forces the inputted signal to be transmitted through coarse selectable delay elements 1709aand 1709b. The signal outputted from coarse selector 1707 through signal out 1711 would then have a twelve nanosecond delay (or a fifteen (15) nanosecond delay if fine selectable delay circuit 1702 enables a three (3) nanosecond delay).

As shown, fine selectable delay circuit 1702 and coarse selectable delay circuit 1704 may be utilized in combination to provide up to a forty-five nanosecond signal delay in three nanosecond increments. For example, if a twenty-one nanosecond delay is required, fine selector 1703 would close its first input and open its second input. Similarly, coarse selector 1707 would open its fourth input and close the other inputs. By doing so, the inputted signal must pass through fine delay element 1705 and coarse delay elements 1709a, 1709b, and 1709c which, in combination, produce the required twenty-one nanosecond delay.

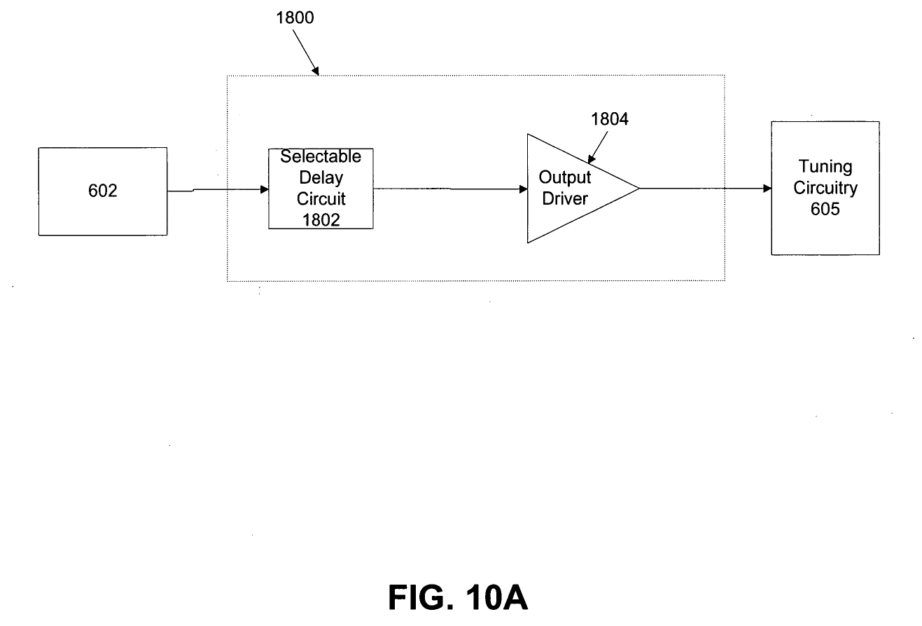

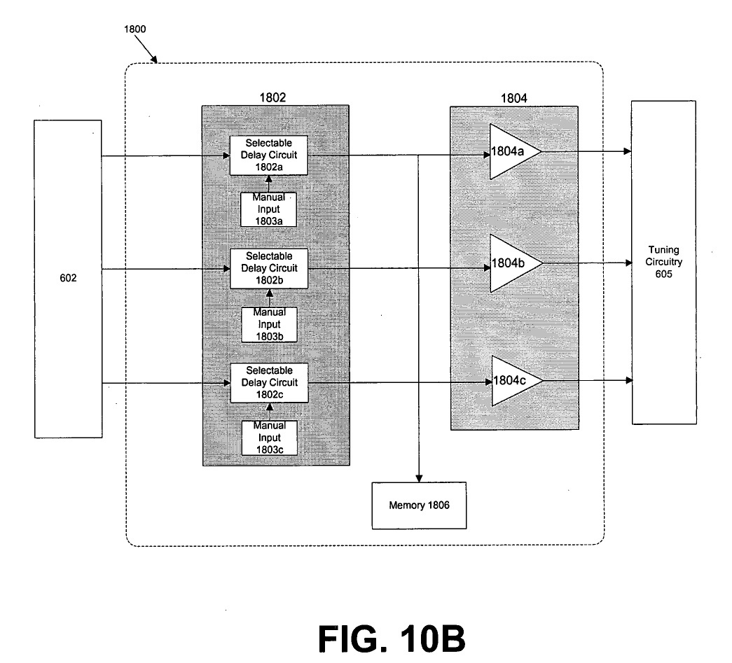

Turning next to FIGS. 10A-10B, depicted is a manually adjustable skew compensation circuit for use in UST 101 to manually adjust the delay applied to any of the red, green, and blue components of the video signal to compensate for the “separation of colors” which occurs when video signals are transmitted over wires of different lengths. As shown in FIG. 10A, manual skew compensation circuit 1800 includes selectable delay circuit 1802 and output driver 1804. During operation, the red, green and blue components of the video signal are transmitted to selectable delay circuit 1802 which applies the appropriate delay to the red, green, and blue components of the video signal as manually adjusted by a user of the system. The manually adjusted video signal is supplied to output driver 1804 which transmits the video signal to tuning circuit 605. (See FIG. 6H and its associated description for a detailed description of tuning circuit 605).

When a user of the user workstation elects to connect to a different remote computer, a pulse is injected by one-shot circuit 315 located in CIM 115 (FIG. 1). The pulse is received at manual skew compensation circuit 1800 from port 602. The pulse is then transmitted to output driver 1804 for display on video monitor 105. If all three pulses arrived at the same time, the screen of video monitor 105 should appear black. However, if the pulses arrived skewed, the monitor would display a color. To correct the skew, a user manually adjusts the delay to the red, green, and blue components of the video signal utilizing manual inputs. For example, the user may utilize dials located on the housing of CIM 115 to manually adjust the delay to the red, green, and blue components of the video signal. Alternatively, the manual delay may be implemented utilizing software pre-loaded onto CIM 115. The user's settings are then stored in memory 1806 so that the manual skew adjustment only has to be performed once (even if the user switches to a different computer and later returns).

Referring next to FIG. 10B, depicted is an enhanced block diagram of manual skew compensation circuit 1800 of FIG. 10A. Here, the red, green, and blue differential video signals arrive through port 602 at manual skew compensation circuit 1800 where they are supplied to selectable delay circuit 1802. Selectable delay circuit 1802 contains red selectable delay circuit 1802a, green selectable delay circuit 1802b, and blue selectable delay circuit 1802c which apply the appropriate signal delay to the red, green, and blue components of the video signal, respectively. Selectable delay circuit 1802 additionally contain red manual input 1803a, green manual input 1803b, and blue manual input 1803c. In this embodiment, red selectable delay circuit 1802a, green selectable delay circuit 1802b, and blue selectable delay circuit 1802c each contain a number of delay circuits which produce a known delay. The delay circuits are preferably LC delay circuits which simulate an extended transmission line. However, the system may utilize any delay circuit capable of producing a signal delay (e.g., snaked traces on a printed circuit board).

To adjust the delay to each of the red, green, and blue components of the video signal, a user utilizes red manual input 1803a, green manual input 1803b, and blue manual input 1803c To manually adjust red selectable delay circuit 1802a, green selectable delay circuit 1802b, and blue selectable delay circuit 1802c, respectively. Manual inputs 1803a, 1803b, and 1803c may be adjusted in a variety of ways. For example, manual inputs 1803a, 1803b, and 1803c may each be connected to a different switch which is controlled by a knob on the housing of UST 101. Alternatively, manual inputs 1803a, 1803b, and 1803c may be implemented in software, whereby a user can utilize keyboard 103a and/or cursor control device 107b to adjust the delay to each of the red, green, and blue components of the video signal.

After the appropriate signal delays have been applied to the red, green, and blue components of the video signal by selectable delay circuit 1802, the video signal enters output driver 1804. Output driver 1804 contains red output driver 1804a, green output driver 1804b, and blue output driver 1804c which output the red, green, and blue components of the video signal, respectively, to tuning circuitry 605. The user's settings are then stored in memory 1806 so that the manual skew adjustment only has to be performed once.

While the present invention has been described with reference to the preferred embodiment and several alternative embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention. It should be appreciated that the present invention is capable of being embodied in other forms without departing from its essential characteristics.

1-21. (canceled)

22. A system for providing video signal compensation, said system comprising:
a video signal compensating circuit for receiving video signal components of a video signal including red, green and blue video signals from a remote video source, determining a skew in receipt of said video signal components, and determining one or more delays to apply one or more of said components; and
a delay circuit coupled to said video signal tuning circuit for applying said delay or said delays said components.

23. A system according to claim 22, further comprising a signal injection circuit for injecting a plurality of test pulses for receipt by said video signal compensating circuit for said determining said delay or delays.

24. A system according to claim 23, wherein each of said test pulses is a square wave.

25. A system according to claim 23, wherein said signal injection circuit injects said test pulses upon receipt of a control signal from said video signal compensating circuit.

26. A system according to claim 22, further comprising memory coupled to said video signal compensating circuit for storing values of said delays.

27. A system according to claim 26, wherein said video signal compensating circuit measures said skew by comparing a combined amplitude of said test pulses to a reference amplitude.

28. A system according to claim 27, wherein said video signal compensating circuit determines said delay or said delays by measuring said skew for each combination of said components received utilizing said delay circuit, storing results of said measuring in said memory, comparing said results to said reference amplitude, and calculating said delay or said delays closest to said reference amplitude.

29. A system according to claim 22, wherein said delay circuit includes at least one inductor-capacitor circuit.

30. A system for according to claim 22, wherein said delay circuit includes at least one printed circuit board comprising at least one printed delay circuit.

31. A system according to claim 22, wherein said delay circuit includes a red delay circuit, a green delay circuit and a red delay circuit, each of said red, green and blue delay circuits being coupled to video signal compensating circuit.

32. A system according to claim 22, further comprising a override circuit for providing manual adjustment of said delay circuit.

33. A switching system including circuitry for providing compensation of video signals including red, green and blue components, said system comprising:
a computer interface device for transmitting test pulses and video signals, said computer interface device including a signal injection circuit for generating said test pulses;
a user interface device coupled to said computer interface device, said user interface device including a signal receiving circuit for receiving said test pulses and said video signals from a remote video source, and a delay circuit for determining a skew in receipt of said video signal components and for determining one or more delays to apply one or more of said components.

34. A system according to claim 33, wherein said delay circuit includes at least one inductor-capacitor circuit.

35. A system according to claim 33, wherein said delay circuit includes at least one printed circuit board comprising at least one printed delay circuit.

36. A system according to claim 33, wherein each of said test pulses is a square wave pulse.

37. A system according to claim 33, wherein said computer interface device is coupled to said user interface device via at least one Category 5 cable.

38. A system according to claim 33, further comprising a switch for selecting transmission of either said test pulses or said video signals.

39. A system according to claim 38, further comprising a control circuit for generating a control signal to control said switch.

40. A system according to claim 33, further comprising a composite switch for creating composite signals comprising said test pulses and said video signals.

41. A system according to claim 40, further comprising an extract circuit for extracting said test pulses from said composite signals.

42. A system according to claim 40, further comprising an extract circuit for extracting said video signals from said composite signals.

43. A method for compensating for skew introduced during transmission of video signals having red, green and blue components, said method comprising the steps of:
generating test signals at a computer interface, said signals including one such signal for each of said red, green and blue components;
receiving said test signals at a user interface;
calculating a difference of time in said receiving;
determining a delay for application to one or more of said components;
producing a signal for introducing said delay; and
applying said delays to one or more of said components.
